(19) United States
(12) Patent Application Publication
(10) Pub. No.: US 2024/0320766 A1
(43) Pub. Date: Sep. 26, 2024

(54) Systems, Methods, and Media for Managing the Obtaining of Services

(71) Applicant: Direct Supply, Inc., Milwaukee, WI (US)

(72) Inventors: Timothy L. Ernst, Grafton, WI (US); Charles W. Fastner, Pewaukee, WI (US); Mark W. Centgraf, Mequon, WI (US); Randy S. Oakley, JR., Waukesha, WI (US)

(21) Appl. No.: 18/213,747

(22) Filed: Jun. 23, 2023

Related U.S. Application Data
(63) Continuation of application No. 18/126,271, filed on Mar. 24, 2023.

(51) Int. Cl. G06Q 50/16; G06Q 30/0601

(52) U.S. Cl. CPC G06Q 50/163; G06Q 30/0631; G06Q 30/0641

(57) ABSTRACT

In accordance with some embodiments of the disclosed subject matter, mechanisms (which can, for example, include systems, methods, and media) for maintaining components of a unit are provided. In some embodiments, a method comprises: receiving an indication that a unit is ready to be turned; generating a customized user interface for assessment of the unit based on a template; receiving a request, from a remote computing device, for the user interface; causing the remote device to present the user interface; receiving, via the remote device, input indicating that a component should be replaced; receiving, from the remote device, an image of the component; receiving, from a second remote computing device associated with a designated user, input indicating that replacement of the first component is approved; and causing a notification to be presented via the remote computing device indicating that replacement of the first component is approved.

### CROSS-REFERENCE TO RELATED APPLICATIONS

This application is a continuation of U.S. patent application Ser. No. 18/126,271 filed Mar. 24, 2023, which is incorporated herein by reference in its entirety for all purposes.

### BACKGROUND

Operators of facilities, such as senior living facilities, acute care facilities, prison facilities, school systems, hotels, and the like, often operate multiple facilities over a large geographic area. Performing maintenance and repair of assets at each facility is often delegated to a maintenance director, or other local employee that can be on site at the facility. Additionally, when a unit becomes vacant, the same employee may be responsible for making any repairs that are needed to get the unit ready for a new resident. However, a maintenance director may not be able to perform all of the service tasks that are needed and can be responsible for hiring contractors to perform at least some services. In a senior living setting, or other setting in which health and safety are of paramount importance, properly maintaining facilities is an important task, which can result in lost revenue, fines and other adverse consequences if facilities are not adequately maintained. This may cause maintenance employees to err on the side of hiring an outside contractor with which they are familiar to ensure that maintenance is performed properly without undertaking a time consuming quote process. However, a familiar service provider may not be the best suited service provider to perform the maintenance (e.g., if it is outside the service providers area of expertise), and/or may not be cost competitive. This can exacerbate costs and may lead to repeat service calls if the maintenance is not initially performed correctly.

Accordingly, new systems, methods, and media for automatically obtaining maintenance are desirable.

### SUMMARY

In accordance with some aspects of the disclosed subject matter, systems, methods, and media for obtaining services are provided. In accordance with some aspects of the disclosed subject matter, a method is provided for maintaining components of a facility using a customized user interface. The method can include causing a user interface to be presented and receiving, via the user interface, a request for service to a particular asset at a particular facility, wherein the particular facility is associated with a geographic location, and wherein the particular asset is associated with an asset type. The method can also include receiving a ranked list of service providers, wherein a ranking of the ranked list is based on a performance metric associated with each of the plurality of service providers and presenting, via the user interface, at least a portion of the ranked list. Furthermore, the method can include receiving, via the user interface, a selection of a particular service provider and transmitting, to a server, a request to perform the requested service.

In accordance with other aspects of the disclosure, a method is provided for coordinating maintaining components of a facility across a plurality of facilities. The method can include receiving, at a server, a request from a user device for service to be performed for a particular asset at a particular facility, wherein the particular facility is associated with a geographic location, and wherein the particular asset is associated with an asset type. The method can also include compiling a ranked list of service providers, wherein a ranking of the ranked list is based on a performance metric associated with each of the plurality of service providers and sending, to the user device, at least a portion of the ranked list. Furthermore, the method can include receiving, at the server, a request to have a selected particular service provider perform the requested service at the particular facility and communicating the request to perform the requested service at the particular facility to the selected particular service provider.

The foregoing and other aspects and advantages of the invention will appear from the following description. In the description, reference is made to the accompanying drawings which form a part hereof, and in which there is shown by way of illustration a preferred embodiment of the invention. Such an embodiment does not necessarily represent the full scope of the invention, however, and reference is made therefore to the claims and herein for interpreting the scope of the invention.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a geographically distributed network of facilities at which a service is managed by an operator in accordance with some aspects of the disclosed subject matter.

FIG. 2A shows an example of a system for automatically obtaining maintenance at facilities associated with various operators and property owners in accordance with some aspects of the disclosed subject matter.

FIG. 2B shows an example of a system for automatically managing maintenance identifying appropriate service providers and scheduling maintenance at a facility in accordance with some aspects of the disclosed subject matter.

FIG. 3 shows an example of a system for automatically managing maintenance in accordance with some aspects of the disclosed subject matter.

FIG. 4 shows an example of hardware that can be used to implement server and computing device in accordance with some aspects of the disclosed subject matter.

FIG. 5 shows an example of a process for automatically managing maintenance at a facility in accordance with some aspects of the disclosed subject matter.

FIG. 6 shows an example of a process for automatically receiving a request for maintenance associated with an asset at a facility in accordance with some aspects of the disclosed subject matter.

FIG. 7 shows an example of a process for automatically identifying and recommending appropriate service providers to respond to a request for maintenance associated with an asset at a facility in accordance with some aspects of the disclosed subject matter.

FIG. 8 shows an example of an information flow for automatically managing maintenance at a facility in accordance with some aspects of the disclosed subject matter.

FIG. 9A shows an example of a user interface for automatically managing maintenance at a facility in accordance with some aspects of the disclosed subject matter.

FIG. 9B shows an example of a user interface for initiating a service request in accordance with some aspects of the disclosed subject matter.

FIG. 9C shows an example of a user interface for selecting a particular initiating a service request in accordance with some aspects of the disclosed subject matter.

FIG. 9D shows an example of a user interface for indicating an urgency associated with a service request in accordance with some aspects of the disclosed subject matter.

FIG. 9E shows an example of a user interface for specifying a nature of an emergency that led to selection of a critical emergency user interface element in accordance with some aspects of the disclosed subject matter.

FIG. 9F shows an example of a user interface for indicating whether repair or replacement is required for the service request in accordance with some aspects of the disclosed subject matter.

FIG. 9G shows an example of a user interface for specifying details of an asset associated with the service request in accordance with some aspects of the disclosed subject matter.

FIG. 9H shows an example of a user interface for specifying contact information to be associated with the service request in accordance with some aspects of the disclosed subject matter.

FIG. 9I shows an example of a user interface for indicating a selection of a preferred service provider from a subset of recommended service providers in accordance with some aspects of the disclosed subject matter.

FIG. 9J shows an example of a user interface for verifying details associated with a service request in accordance with some aspects of the disclosed subject matter.

FIG. 9K shows an example of a user interface for confirming that service has been requested from a service provider in accordance with some aspects of the disclosed subject matter.

FIG. 10 shows an example diagram of a process for automatically identifying and recommending appropriate service providers to respond to a request for service associated with an asset at a facility in accordance with some aspects of the disclosed subject matter.

FIG. 11 shows an example diagram of scoring for a service provider that has insufficient data for at least one category in accordance with some aspects of the disclosed subject matter.

FIG. 12A shows another example of a user interface for initiating a service request in accordance with some aspects of the disclosed subject matter.

FIG. 12B shows another example of a user interface for selecting a particular initiating a service request in accordance with some aspects of the disclosed subject matter.

FIG. 13A shows an example of a user interface for a service provider showing service event scores for the service provider and anticipated scores for a new service request in accordance with some aspects of the disclosed subject matter.

FIG. 13B shows an example of a user interface for a service provider showing performance of the service provider on the various metrics in accordance with some aspects of the disclosed subject matter.

FIG. 13C shows another example of a user interface for a service provider showing performance of the service provider on the various metrics in accordance with some aspects of the disclosed subject matter.

FIG. 14A shows an example of a user interface for a service provider to define a service area for the service provider in accordance with some aspects of the disclosed subject matter.

FIG. 14B shows another example of a user interface for a service provider to define a service area for the service provider in accordance with some aspects of the disclosed subject matter.

FIG. 15A shows an example of a user interface for a service provider to define and/or modify services and/or capabilities that the service provider offers in accordance with some aspects of the disclosed subject matter.

FIG. 15B shows another example of a user interface for a service provider to define and/or modify services and/or capabilities that the service provider offers in accordance with some aspects of the disclosed subject matter.

### DETAILED DESCRIPTION

In accordance with various aspects, mechanisms (which can, for example, include systems, methods, and media) for automatically obtaining services, including maintenance are provided.

In some aspects, mechanisms described herein can automatically identify and recommend service providers based on performance metrics and service network health dynamics to facilitate customers to make more informed decisions on what service provider(s) is best suited to fulfill a particular service request. In some aspects, mechanisms described herein can facilitate customization of the scoring system (e.g., based on user input explicitly altering weighting based on a user's expressed preferences, based on user input indicative of a user's revealed preferences). For example, mechanisms described herein can receive input to configurable weighting of one or more scoring metrics. As another example, mechanisms described herein can change one or more scoring mechanisms based on customer buying decisions using a machine learning model(s) on a per transaction basis (e.g., to attempt to predict revealed customer preferences that may better predict user buying behaviors than a user's expressed preferences).

In some aspects, mechanisms described herein can utilize information about multiple service providers to analyze into market competitiveness of service provider, which can foster greater competition between service providers. Additionally, in some configurations, and entrench a link between service provider performance and future opportunities.

In some configurations, mechanisms described herein can be used to implement a service provider scoring system based on local, market, and/or provider performance factors (e.g., implemented using a remote server). In some configurations, mechanisms described herein can make service provider recommendations that account for service network health considerations, such as new service provider positioning and establishing performance trends for lower performing providers that may have improved.

In some configurations, mechanisms described herein can facilitate input of preferences (e.g., by a corporate user associated with multiple facilities, by a user associated with a facility, etc.) for particular providers and/or cost options (e.g., a preference to select a relatively low cost service provider from among available service providers). In such configurations, mechanisms described herein can utilize such preferences to weight one or more scoring metrics and/or alter an order in which service providers are presented to a user. Additionally, mechanisms described herein can utilize such preferences to analyze whether a user is selecting service providers in accordance with such preferences.

In some configurations, mechanisms described herein can receive indications of service providers selected by users, and data (e.g., user feedback, service provider feedback, etc.), on a per transaction basis, and such data can be used to improve scoring for the user to better match recommendations with needs for that user.

In some configurations, when a user submits a request for service, the user can be presented with service provider options, which can include the hourly rate of the service provider, and/or an indication of whether the service provider has been recently used (e.g., if the service provider was last user in the user's facility, when the service provider was last used at the facility, etc.).

In some configurations, additional information can be used to assist a user in selecting a service provider to fulfill a service request. In some configurations, additional information can present service provider performance metrics in a form that facilitates improved user decision making, which can facilitate a link between service provider performance and future opportunities.

In some configurations, when a user initiates a new service request, the user can be prompted to choose a service category (e.g., electrical, plumbing, HVAC) and enter details (e.g., asset details, urgency level, description of the issue), which can capture information about the service to be performed. In some configurations, after a user has selected a category and/or entered details, mechanisms described herein can identify service providers to recommend, and can present recommended service providers (e.g., presenting cards for each of a set of top service providers, such as top four providers). In such configurations, each recommended service provider card can include identifying information, rating information (e.g., customer ratings), response time (e.g., average response time), and standard rate (e.g., a price per hour charged by the service provider for standard service). In some configurations, a recommended service provider card can include additional indicators (e.g., tags, flags, etc.) with information such as “Recommended,” “Last Used,” “Corporate Preference,” etc.

In some configurations, a response time of the service provider (e.g., shown as a graphical indicator, such as a stopwatch image) and include text such as “Great” for the best options, “Above Average” for top third, “Average” for middle third, and “Below Average” for bottom third.

In some configurations, mechanisms described herein can facilitate searches for providers (e.g., by name), and/or a sort option(s) for sorting providers (e.g., other than using a scoring described herein).

In some configurations, a rating presented in connection with a service provider can be a star rating (e.g., a five-star rating) based on an average of customer submitted ratings.

In some configurations, mechanisms described herein can highlight promotional rates for new service providers (e.g., service providers that have not been used recently via mechanisms described herein), which can facilitate an ongoing performance track record for new or otherwise not recently used service providers.

In some configurations, mechanisms described herein can filter out service providers based on service provider capabilities compared with the service request details provided by a user requesting service. For example, this can include factors such as the service category (e.g., a heating, ventilation, and air conditioning (HVAC) contractor can be filtered out for a plumbing service request to fix a toilet). In some configurations, mechanisms described herein can filter service providers based on urgency level (e.g., some service providers may only do non-urgent requests).

In some configurations, mechanisms described herein can filter service providers based on any other suitable factor, such as user requirements and/or regulatory requirements that a service provider must meet (e.g., a requirement that a service provider be vaccinated), that filter out service providers that do not meet the requirement(s). Additionally or alternatively, in some configurations, a score for a service provider can be adjusted, positively or negatively, based on whether the service provider meets the requirement(s). In some configurations, an indicator(s) (e.g., a tag, a flag, text, etc.) and/or message can be presented on a user interface element (e.g., a card) associated with the service provider in a customer-facing user interface indicating whether the service provider does or does not meet the requirement(s).

In some configurations, mechanisms described herein can score and sort service providers before presenting recommendations in a user-facing user interface. In some configurations, mechanisms described herein can score service providers on various attributes and/or metrics, such as speed (e.g., indicative of responsiveness), price, quality, and ease-of-use. In some configurations, scoring can be based around a 100 point system. In some configurations, attributes that are used to score a service provider and/or weights associated with such attributes can differ depending on service request urgency. For example, whether a request is urgent or non-urgent (e.g., requests can be characterized as P1—a 2-hour response expectation, P2—a 5-hour response expectation, P3—a 24-hour response expectation, and P4—a request for a project quote. In such an example, attributes and/or weights used to score can vary based on response expectations (e.g., cost can be down-weighted when making an urgent request). In some configurations, a quality attribute can be comprised of multiple components. For example, a service provider can be associated with a first time fix rate, and a five-star rating.

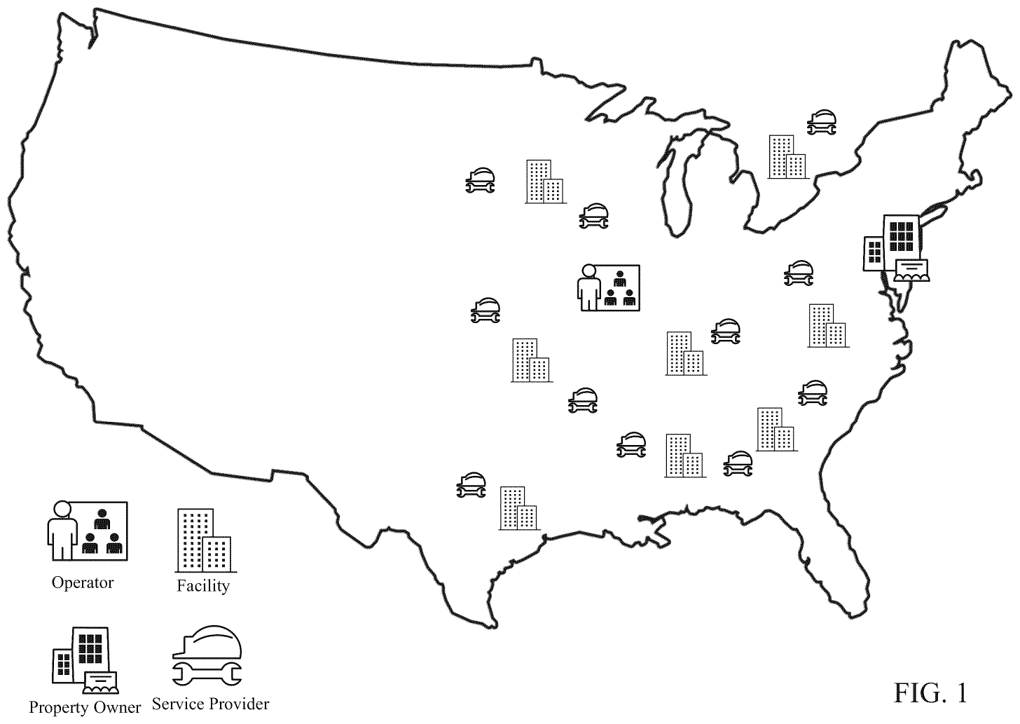

FIG. 1 shows an example of a geographically distributed network of facilities at which a service is managed by an operator in accordance with some configurations of the disclosed subject matter. As shown in FIG. 1, an operator located in a particular geographic location can operate facilities in many different geographical locations. For example, the operator can provide access to living space (e.g., via leased units) and/or provide a service (e.g., assistance with various tasks, healthcare services, etc.) at the various facilities. In the context of many facility types (such as senior living facilities, acute care facilities, prison facilities, school systems, hotels, and the like), an operator may operate many different facilities in different locations, and may provide multiple different types of services, sometimes within the same facility. The operator of the facilities may or may not own the property associated with the facilities. For example, one or more property owners may own the real property and/or structures associated with the facility and may contract with an operator to operate a senior living facility providing one or more services at the property. The property owner may be any type of organization, such as a real estate investment trust (REIT).

As part of operating a facility, the operator may be responsible for providing services to one or more facilities, including maintenance of facilities. The operator may hire one or more employees (sometimes referred to herein as a maintenance director) to supervise services, such as maintenance, at a particular facility, or a group of closely located facilities. The maintenance director may be responsible for resolving requests for maintenance and/or repair to occupied units, ensuring that various assets, such as systems (e.g., heat, air conditioning, plumbing, electrical, etc.) are maintained in working order, and that other assets (e.g., carpet, doors, trim, countertops, appliances, etc.) are maintained in good repair. While a maintenance director may be capable of performing some maintenance, repair, and/or replacement, but may need to hire outside contractors to perform certain tasks. Often, contractors operate in relatively small areas, and thus different facilities within the same organization may not be able to use the same contractors. This can make it difficult for the operator to identify service providers that can be expected to perform the requested services at a competitive cost, with a needed turnaround time, and/or with a desired level of quality.

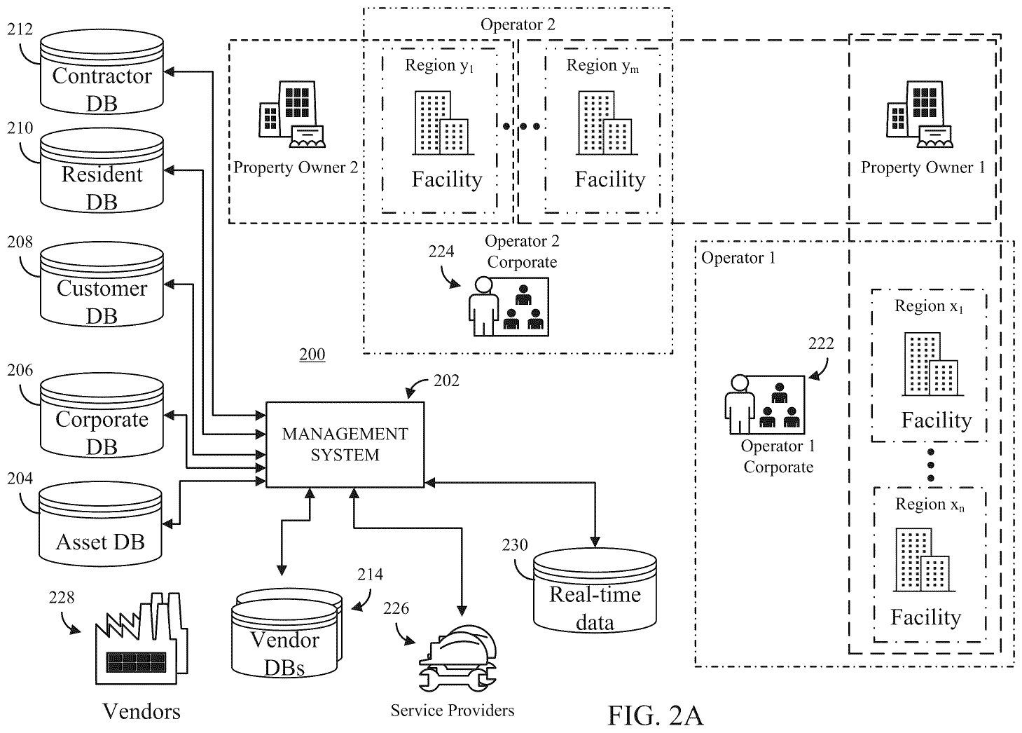

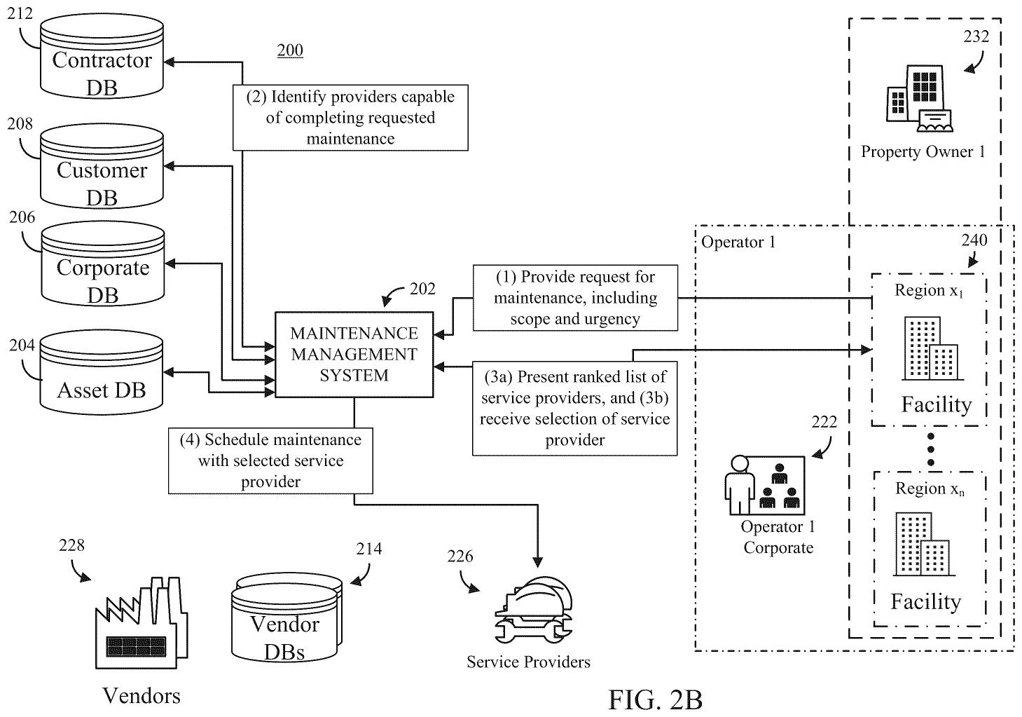

FIG. 2A shows an example 200 of a system for automatically obtaining services, including maintenance services, at facilities associated with various operators and property owners in accordance with some configurations of the disclosed subject matter. As shown in FIG. 2A, a management system 202 can communicate with and/or maintain various databases, such as an asset database 204, a corporate database 206, a customer database 208, a resident database 210 (and/or electronic health records (EHR) system, which may be sometimes referred to as an electronic medical records (EMR) system), a contractor database 212, one or more vendor databases 214, and/or real-time data sources 230. In the following non-limiting example, the management system 202 may be configured for or used for providing services that are focused on maintenance. As such, the management system 202 may be referred to as a maintenance management system 202 or the services being managed may be directed toward maintenance. However, maintenance is a non-limiting example of a service that may be managed in accordance with the present disclosure and the systems and methods described herein may likewise apply to other services.

In some configurations, asset database 204 can include asset history data associated with various facilities, such as assets associated with a first operator 222 (e.g., operator 1), and/or a second operator 224 (e.g., operator 2). In some configurations, asset database can include information about any suitable type of asset, such as assets that can be associated with a unit, such as walls, ceiling, trim, paint (e.g., wall paint), doors, windows, window treatments, floors, carpets, plumbing, electrical wiring, electrical outlets, a heating system, a cooling system, detectors (e.g., smoke detectors, carbon monoxide detectors, etc.), fire extinguishers, appliances, cabinets, counter tops, sinks, toilets, shower, bath tub, garbage disposal, furniture, etc. Asset database 204 can include information organized using any suitable technique or combination of techniques. For example, asset database 204 can be organized as a relational database, or a non-relational database.

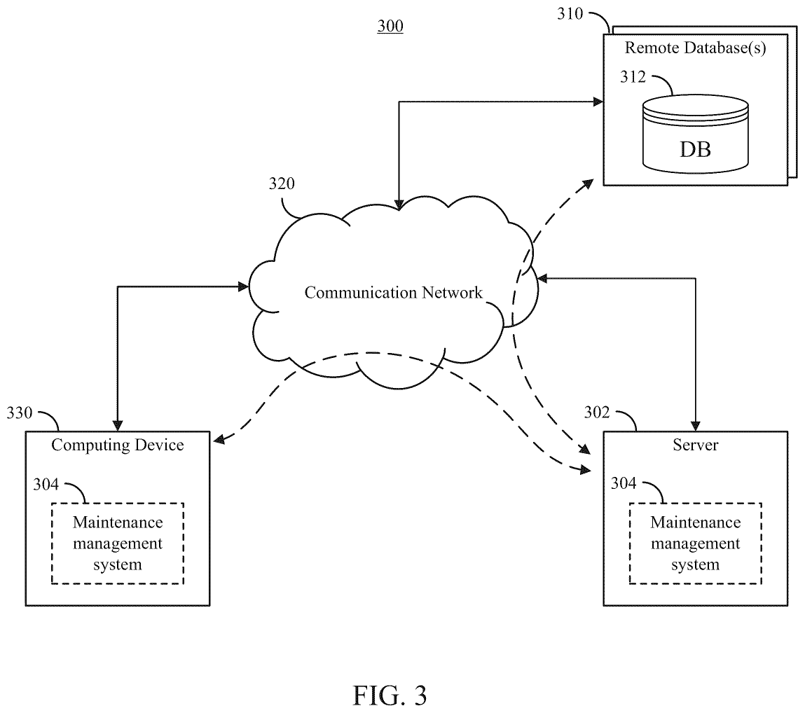

In some configurations, asset database 204 can receive identifying information associated with an asset and can store the identifying information in connection with metadata related to the asset. For example, a mobile device (e.g., computing device 330 described below in connection with FIG. 3) can scan a symbol (e.g., a barcode, a quick response (QR) code, etc.) encoded with identifying information (e.g., an alphanumeric code), and can transmit the identifying information to asset database 204. In such an example, the mobile device can transmit information about the asset (e.g., an asset type, a semantically meaningful name, a location of the object, an indication of when the asset was installed, etc.).

In some configurations, asset database 204 can store information about assets that have been installed at a facility, and metadata related to the asset. Additionally, in some configurations, asset database 204 can store information about repairs and/or other maintenance performed in connection with an asset. For example, asset database 204 can store identifying information associated with various assets, such as unique identifying information (e.g., assigned by maintenance management system 202), semantically meaningful name, an identification number associated with a type of asset (e.g., different types of assets can be associated with a unique alphanumeric code), model information, serial number, lot information, manufacturer, etc. In some configurations, a type of asset can be indicative of any suitable characteristic(s) of the asset. For example, an asset type can include a semantically meaningful category into which the asset can be categorized, such as water heater, boiler, furnace, plumbing, refrigerator, electrical wiring, carpet, etc.). As another example, an asset type can include one or more characteristics of the asset (e.g., indicating a fuel type such as gas, electric, or oil).

As another example, asset database 204 can store identifying information associated with a location of an asset, such as an address, a facility name, a room number, an apartment number, a corridor number, a type of facility (e.g., assisted living, independent living, memory care, skilled nursing, acute care, hospitality, etc.), etc. As yet another example, asset database 204 can store information associated with installation, maintenance, and/or repair of an asset, such as an installation time, a time in service (e.g., a time since the asset was installed). As still another example, asset database 204 can store information about a condition of the asset at a particular time (e.g., documented by an employee, documented by a contractor, etc.). In a more particular example, the condition of the asset can be based on one or more objective criteria, such as “new” when the asset is first installed, and/or one or more subjective criteria (e.g., based on input from a user). As a further example, asset database 204 can store information associated with a resident of a room, such as whether one or more residents uses any mobility assistance devices (e.g., a wheelchair, a motorized wheelchair, etc.), an age of the resident, a number of residents, etc. As another further example, asset database 204 can store information indicative of attributes of an asset, such as color, size, voltage, gas type (e.g., natural gas, propane, etc.), etc.

In some configurations, when an asset is serviced (e.g., installed, repaired, or replaced, and/or when maintenance is performed), a computing device (e.g., a mobile device) can provide information associated with the service to asset database 204. In some configurations, maintenance management system 202 and/or any other suitable system, can use information stored in asset database to predict a useful life of a particular asset. For example, maintenance management system 202 can determine an average useful life of a particular asset and/or type of asset based on a condition of similar assets over time in similar situations (e.g., in similar facilities, with residents having similar characteristics, etc.).

In some configurations, corporate database 206 can store one or more templates associated with an operator (e.g., an operator of senior living facilities), standards associated with the operator, approval policies associated with the operator, and/or any other suitable information that can be used to automatically optimize and/or manage maintenance for the operator. In some configurations, a separate data structure (e.g., a different instance of corporate database 206) can be associated with different operators. For example, first operator 222 can be associated with a first corporate database instance and second operator 224 can be associated with a second corporate database instance. In such an example, the different database instances may or may not be implemented by the same hardware (e.g., one or more servers).

In some configurations, corporate database 206 can store information indicative of tasks that can be performed by one or more employees associated with an operator and/or a particular facility. For example, corporate database 206 can store information indicative of tasks that have been successfully performed by a particular employee, tasks that the employee has been trained to perform, tasks that similar employees (e.g., with similar levels of experience, training, etc.) are able to perform, etc. In some configurations, corporate database 206 can store information indicative of corporate preferences (e.g., provider preferences, service provider cost preferences, etc.), corporate limits (e.g., cost limits imposed by a corporate user, etc.), and/or any other preferences and/or limits provided by a corporate user.

In some configurations, customer database 208 can store information about units associated with an operator and/or one or more facilities. A unit can be any suitable portion of a facility, such as an apartment, a suite, a room, a bed, etc. In some configurations, customer database 208 can store any suitable information about one or more units, such as information indicative of a type of unit (e.g., a number of bedrooms, a number of bathrooms, etc.), information about a price associated with the unit (e.g., rent, price, etc.), size information (e.g., total area, such as square feet or square meter), occupant information (e.g., identifying information of one or more occupants, a number of occupants, a number of pets, a type associated with each pet, etc.), attributes of the unit (e.g., location on the property, such as close to communal dining room; whether the unit has a balcony; quality of fixtures (e.g., low end, high-end, etc.); whether the unit has a bathtub, a shower stall, etc.; whether the unit is wheelchair accessible; whether the unit has grab bars installed, e.g., in the bathroom; and/or any other suitable attributes), and/or any other suitable information about the unit. In some configurations, customer database 208 can store information indicative of assets associated with a unit (e.g., a link to an asset in asset database 204).

In some configurations, resident database 210 can store information about one or more residents of a facility. In some configurations, resident database 210 can be maintained as part of an electronic health record system (e.g., an electronic medical record system) and/or can be populated using information from an electronic health record system. In some configurations, the electronic health record system can be used by an organization and/or facility to securely store and maintain protected health information about patients and/or residents at the facility. Additionally or alternatively, in some configurations, resident database 210 can be used by an organization and/or facility to securely store and maintain information that is not classified.

In some configurations, resident database 210 can be used to securely store and maintain information that may not be considered protected health information about patients. In some configurations, any suitable information about residents can be stored using resident database 210, such as information about the resident's needs and/or preferences (e.g., permission to access unit, wheelchair needs, grab bar needs, dietary needs, dietary preferences, etc.), a length of occupancy, etc.

In some configurations, resident database 210 can be maintained as part of maintenance management system 202 and/or can be maintained separately (e.g., as part of a health information system, by a third party, etc.) and used by maintenance management system 202. In some configurations, system 200 can include multiple resident databases 210 which can be maintained by different entities, and which can include information about different residents, and/or can include different types of information about the same residents.

In some configurations, contractor database 212 can store information about one or more contractors 226 (e.g., service providers). In some configurations, contractor database 212 can store any suitable information about one or more service providers, such as identifying information associated with a service provider, information indicative of a service area associated with a service provider, information indicative of cost to perform one or more services (e.g., to perform installation, maintenance, repair, and/or replacement of one or more assets), information indicative of response times, information indicative of satisfactory performance, information indicative of services performed at various types of facilities (e.g., assisted living, independent living, memory care, skilled nursing, acute care, hospitality, etc.), information indicative of satisfactory performance at various types of facilities (e.g., assisted living, independent living, memory care, skilled nursing, acute care, hospitality, etc.), information indicative of training and/or certification completed by a service provider and/or one or more employees of a service provider, information indicative of customer reviews, etc.

In some configurations, vendor databases 214 can store information about one or more items available from one or more vendors 228 (e.g., suppliers, manufacturers, retailers, wholesalers, etc.) In some configurations, maintenance management system 202 (and/or any other suitable system, such as an order management system described in U.S. Pat. No. 10,685,308, issued Jun. 16, 2020, which is hereby incorporated herein by reference in its entirety), can collect information about products that are stocked and/or are generally available in various regions in which one or more vendors operates. In some configurations, maintenance management system 202 (and/or any other suitable system) can query vendor databases 214 for information about inventory currently available in one or more regions and can facilitate procurement of one or more parts needed to perform a particular service. Additionally, in some configurations, maintenance management system 202 can use information from vendor databases 214 to determine a useful life for assets, which can be used when evaluating whether to recommend repair or replacement of the asset.

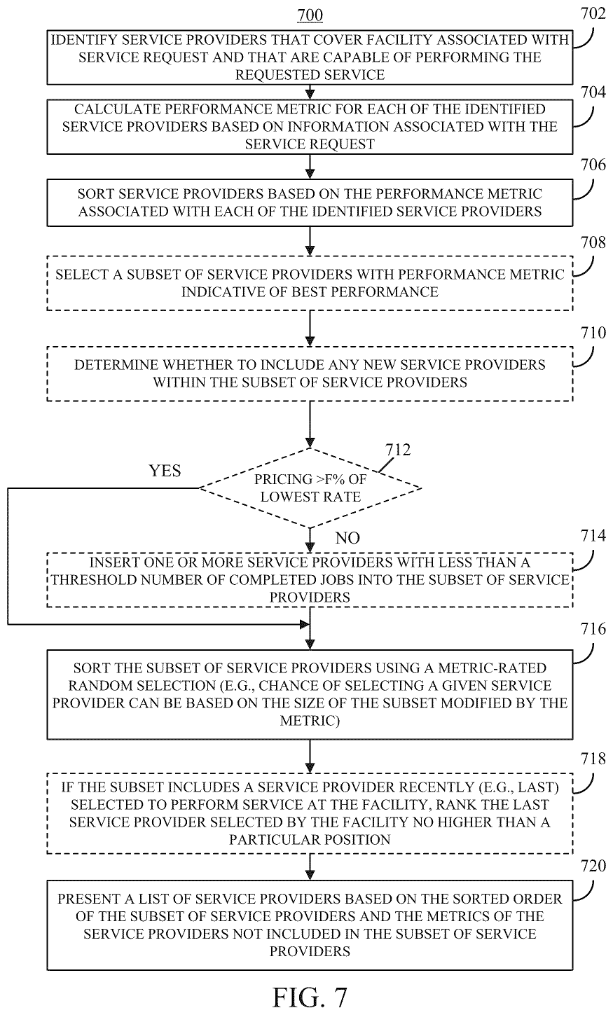

In some configurations, real-time data source(s) 230 can store and/or provide information about one or more conditions that may impact a service provider recommended by maintenance management system 202. For example, real-time data source(s) 230 can store and/or provide real-time traffic data and/or map data (e.g., which can be used to estimate a travel time, route data, etc.). In such an example, real-time traffic data can be used to estimate a likely response time of a service provider. As yet another example, real-time data source(s) 230 can store and/or provide location information associated with a technician (e.g., associated with a mobile device of the technician, associated with a vehicle of the technician, etc.). In such an example, the location information can be used to estimate a likely response time of a service provider based on the real-time location of a technician that is likely to be dispatched to respond to a service request. In a more particular example, real-time location information can be used to determine a speed score for a particular service provider (e.g., as described below in connection with 704 of FIG. 7). In such an example, the real-time location information can be used to calculate a likely response time (e.g., based on a time when the technician is likely to be ready to depart, and a transit time to the location at which the maintenance is to be performed), and the likely response time can be used in addition to, or in lieu of, an average response time (e.g., via a weighted average between a response time, and the likely response time).

As yet another example, real-time data source(s) 230 can store and/or provide weather information. In such an example, the weather data can be used to determine an urgency of a service request (e.g., a service related to heat and/or cooling may be more urgent depending on the current temperature). Additionally, in some configurations, the weather data can be used to estimate an impact on response time (e.g., snow or rain may cause response times to be slower than usual).

Note that, in some configurations, information stored in asset database 204, corporate database 206, customer database 208, resident database 210 (and/or electronic health records system), contractor database 212, vendor databases 214, and/or real-time data source(s) 230 can be stored in a distributed database and/or distributed record that is maintained across various computing devices in a network of computing devices. For example, in some configurations, such data can be stored using blockchain techniques to store and update data in an encrypted and distributed record. As another example, such data can be stored using a secured and encrypted database (e.g., implemented using relational and/or non-relational data stores) to securely store and update data.

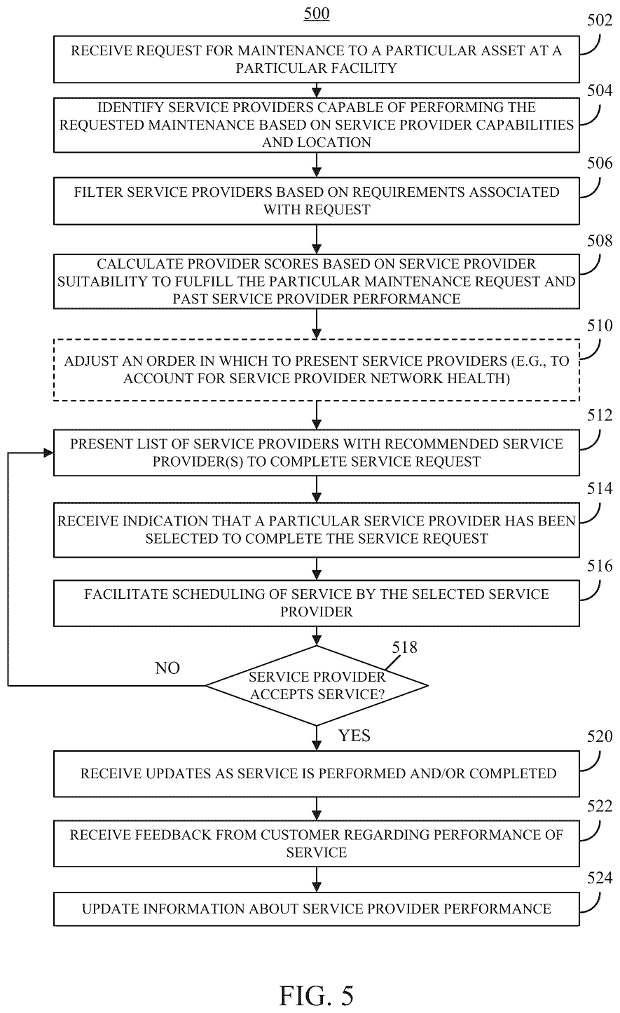

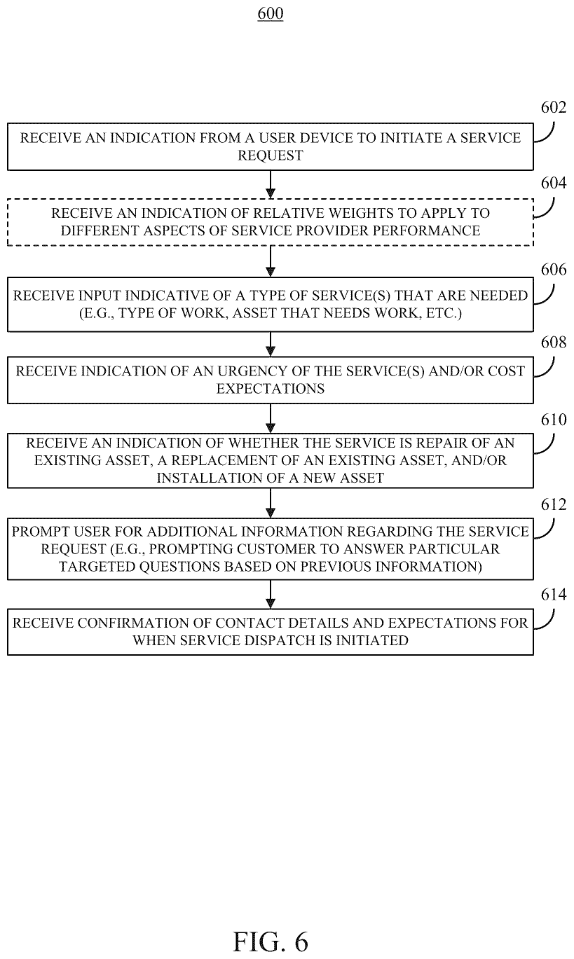

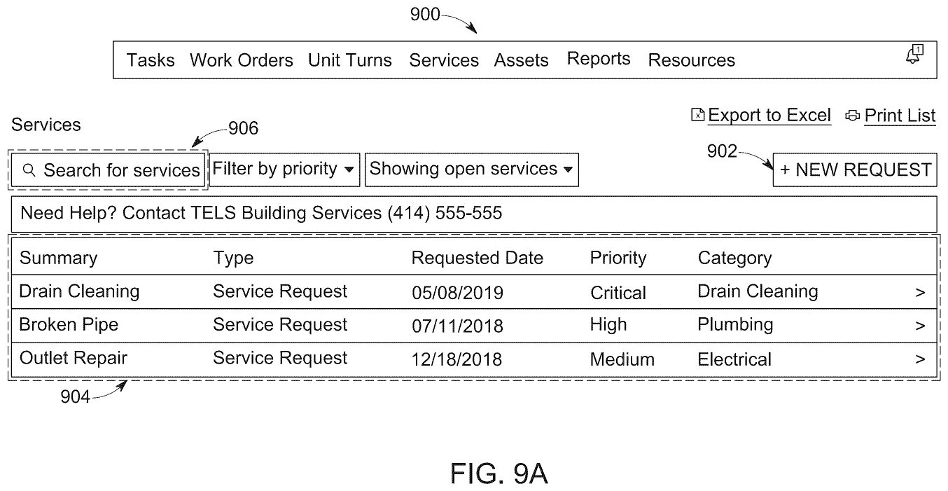

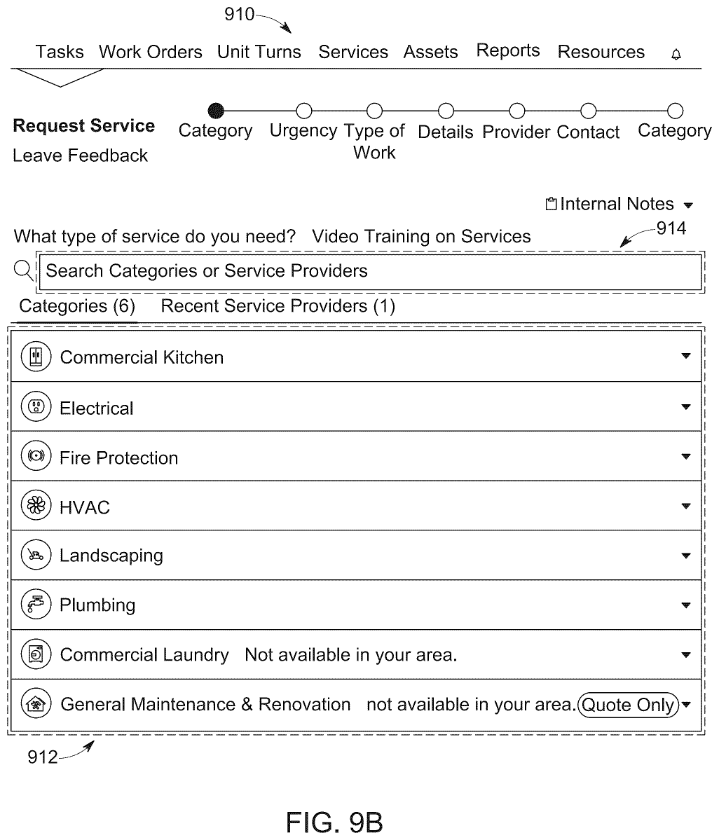

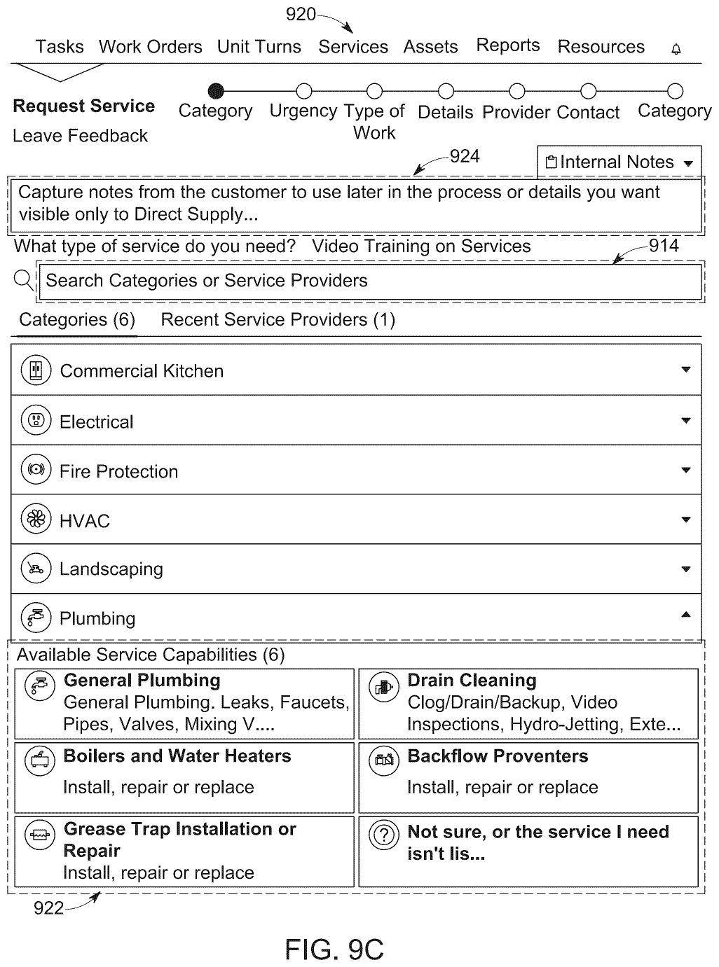

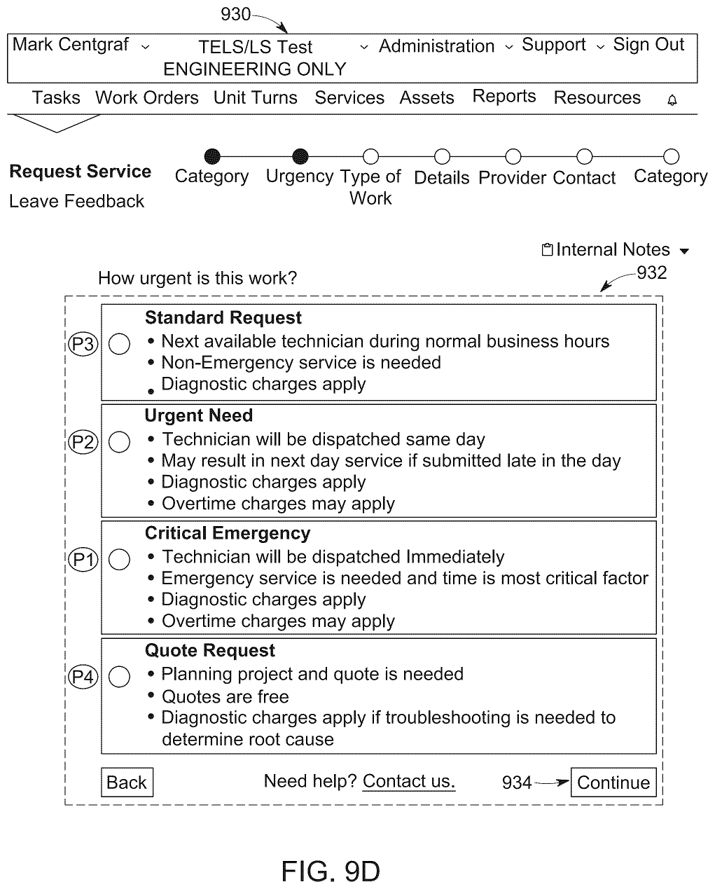

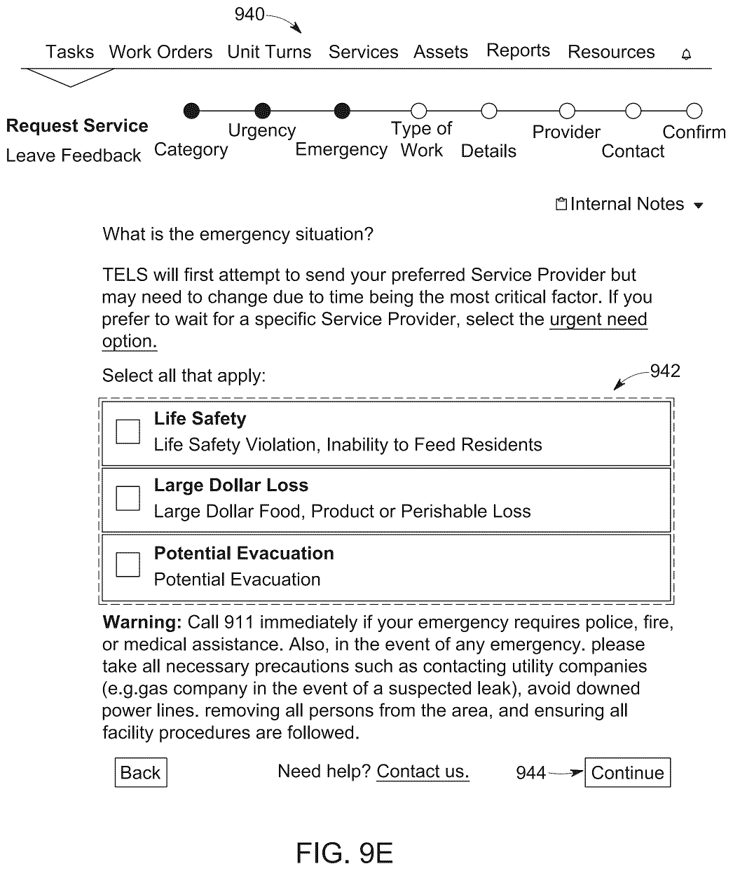

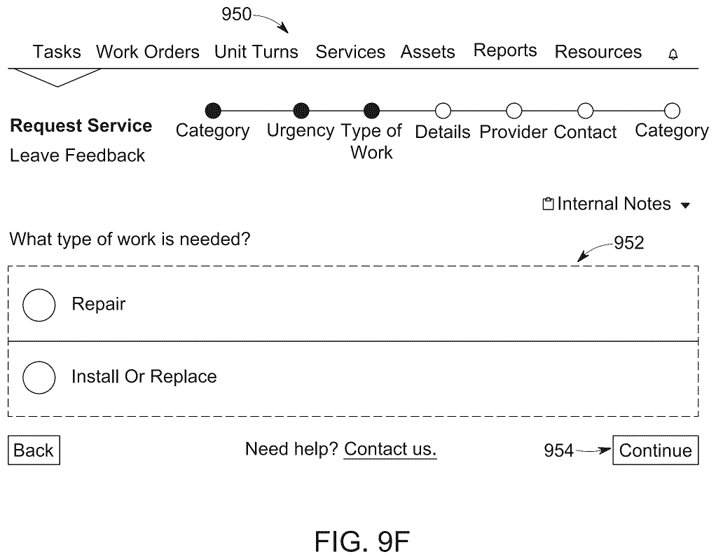

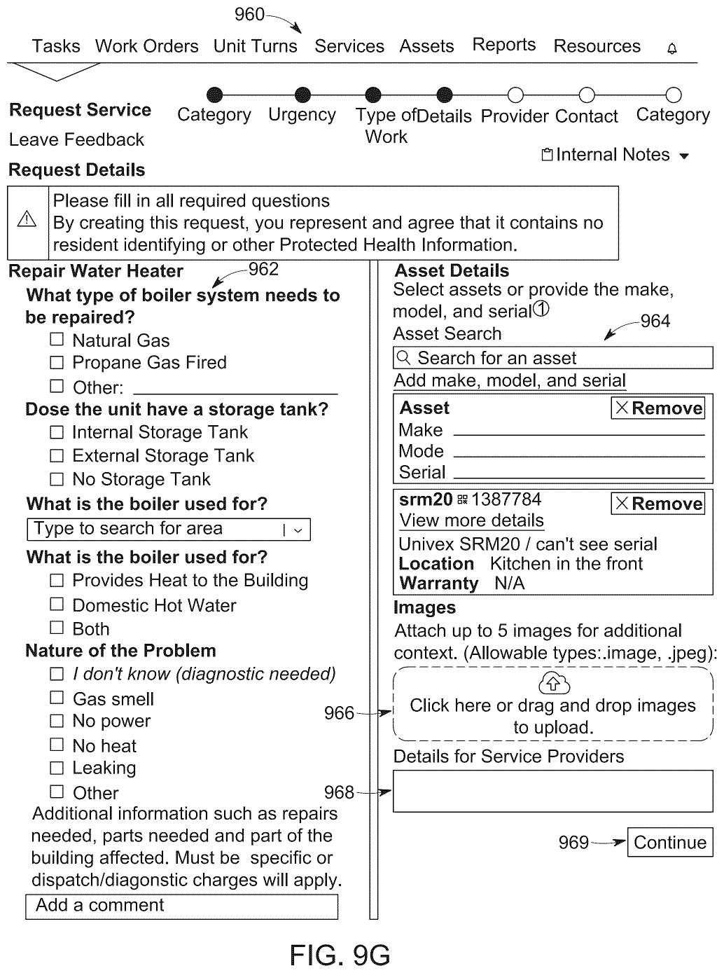

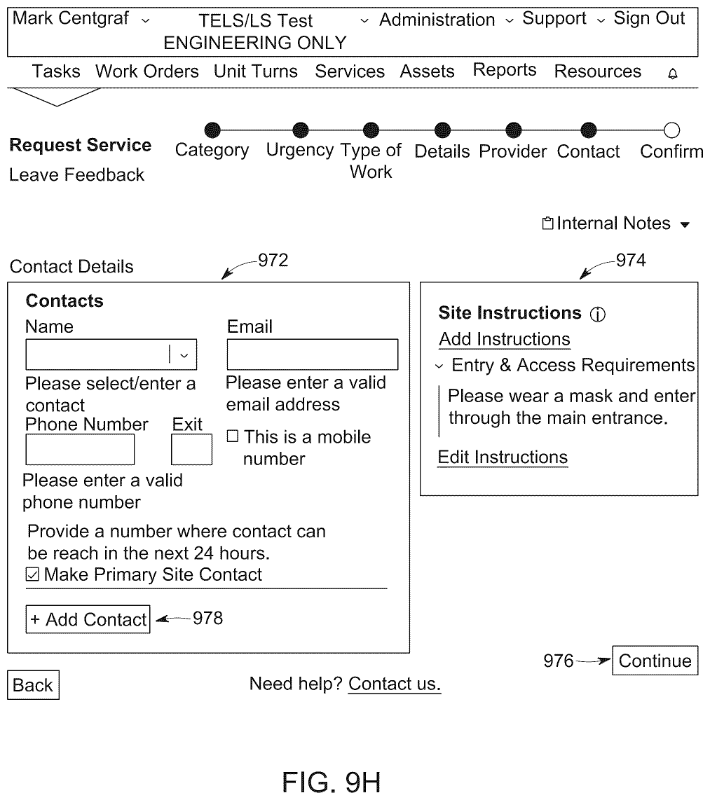

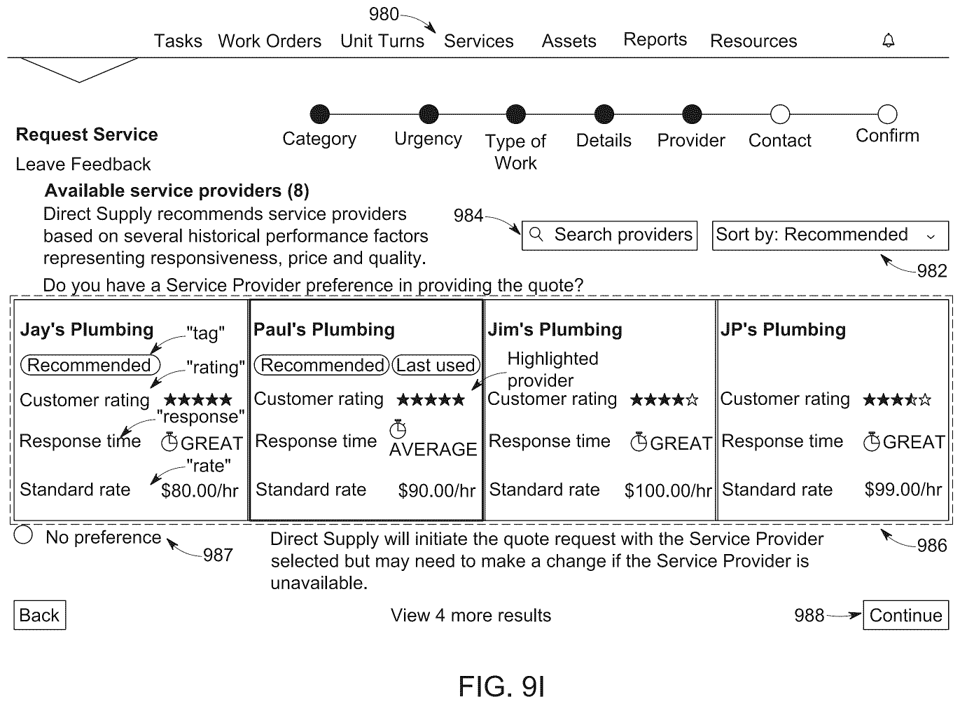

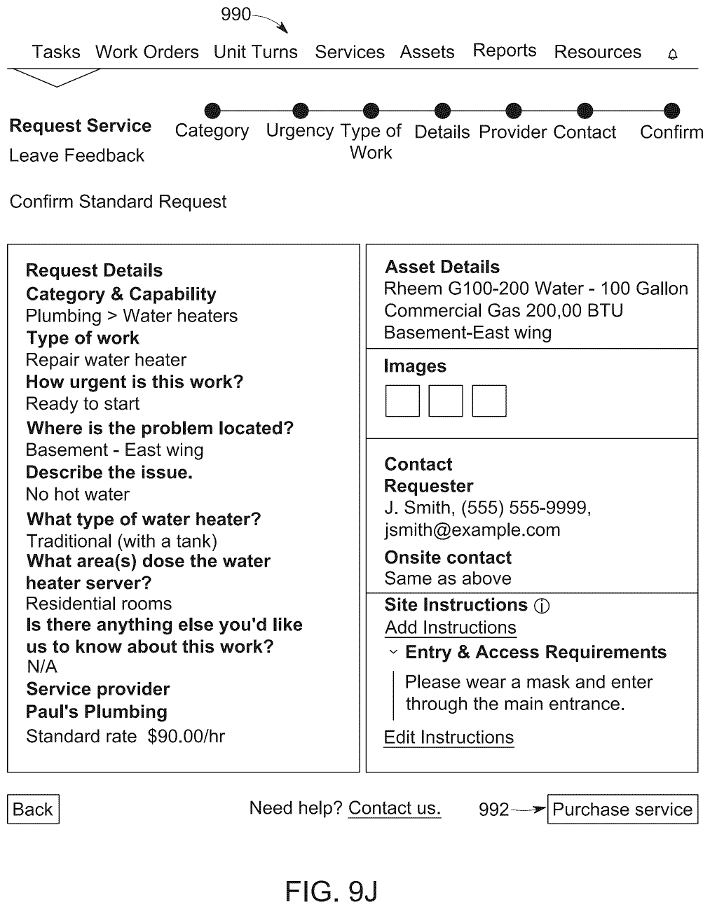

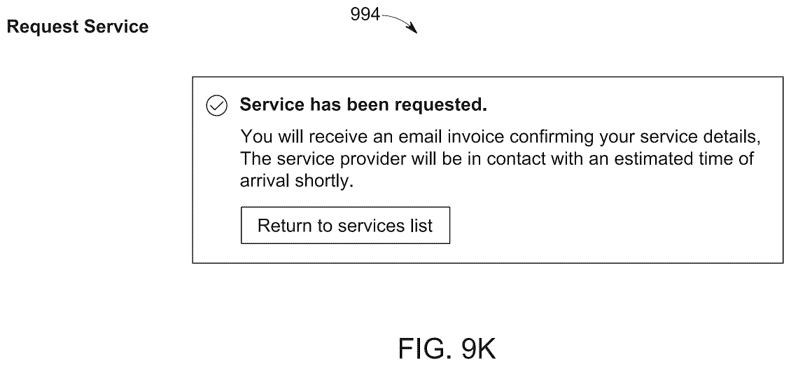

FIG. 2B shows an example of a system for automatically managing maintenance identifying appropriate service providers and scheduling maintenance at a facility in accordance with some configurations of the disclosed subject matter. As shown in FIG. 2B, in some configurations, maintenance management system 202 can receive (at (1)) a request for maintenance, including scope and urgency of the service request from a facility associated with operator 222 and/or a user 240 associated with a particular facility. For example, maintenance management system 202 can receive a maintenance request using any suitable technique or combination of techniques, such as techniques described below in connection with 502 of FIG. 5, 602 of FIG. 6, and FIGS. 9A to 9H.

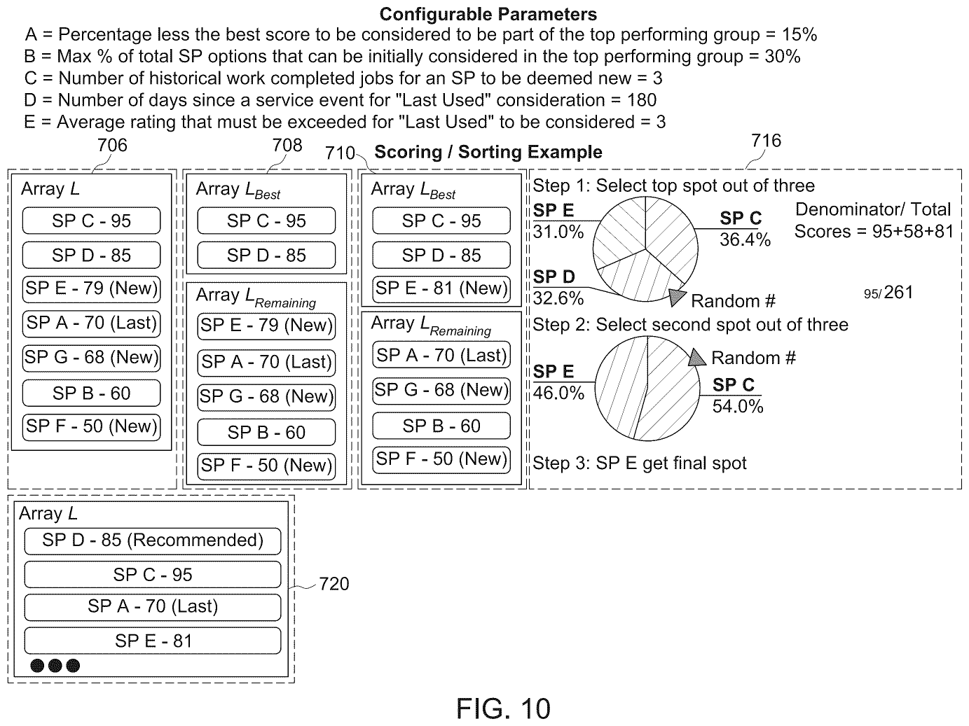

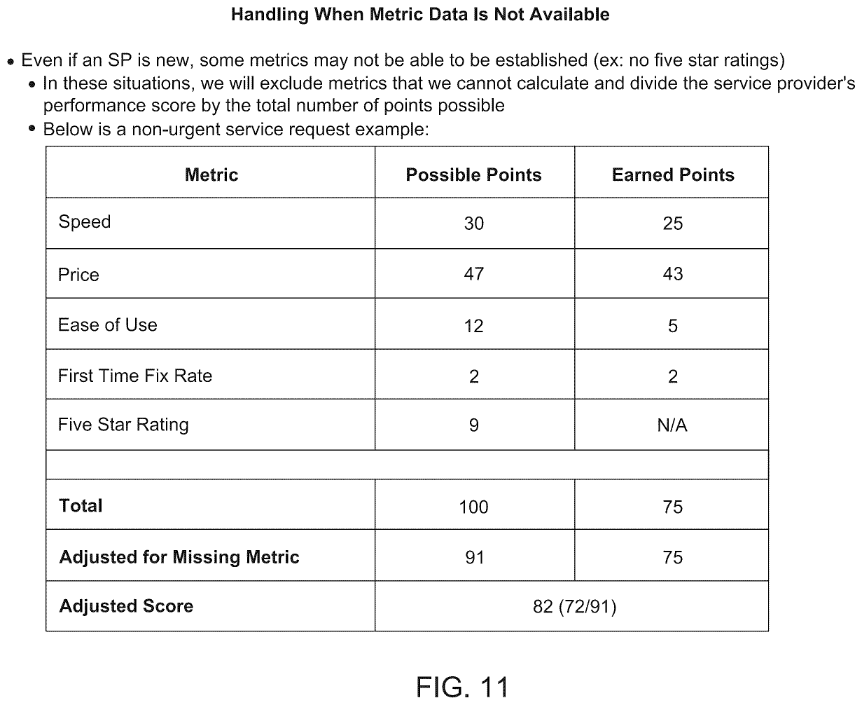

In some configurations, maintenance management system 202 can identify (at (2)) service providers capable of completing the requested maintenance using any suitable technique or combination of techniques. For example, maintenance management system 202 can query contractor database 212 for service providers that are capable of completing the requested maintenance based on the location of the service provider and/or the location of the facility (e.g., whether the service provider provides services at the location where the facility is located, in other words whether the facility falls in the service provider's coverage area), services offered by the service provider (e.g., whether the service provider provides the type of service requested and/or services the type of asset associated with the requested service), and/or any other suitable factors (e.g., based on user and/or regulatory requirements). In some configurations, maintenance management system 202 can identify service providers using any suitable technique or combination of techniques, such as techniques described below in connection with 504-510 of FIG. 5, 702-718 of FIG. 7, FIG. 10, and FIG. 11.

In some configurations, maintenance management system 202 can provide (at (3a)) a ranked list of service providers capable of completing the requested maintenance, which can include one or more recommended service providers, using any suitable technique or combination of techniques. For example, maintenance management system 202 can cause a user interface (e.g., presented by a computing device that initiated the service request) to present the ranked list.

In some configurations, maintenance management system 202 can receive (at (3b)) a selection of a service provider to perform the requested service, using any suitable technique or combination of techniques. For example, maintenance management system 202 can receive an indication that a user interface element associated with the selected service provider was selected via the user interface used to present the ranked list.

In some configurations, maintenance management system 202 can schedule (at (4)) the requested maintenance with the selected ranked list of service providers capable of completing the requested maintenance, which can include one or more recommended service providers, using any suitable technique or combination of techniques. For example, maintenance management system 202 can transmit a request to the selected service provider to request that the service provider complete the requested maintenance.

FIG. 3 shows an example 300 of a system for automatically managing maintenance in accordance with some configurations of the disclosed subject matter. As shown in FIG. 3, a server (or other processing unit) 302 can execute one or more applications to provide access to a maintenance management system 304. In some configurations, maintenance management system 304 can facilitate automatic management of maintenance, initiation of one or more service requests to perform maintenance, identification and ranking of service providers capable of performing the requested maintenance, receiving a selection of a service provider, and initiating service with the selected service provider to perform the requested maintenance.

In some configurations, maintenance management system 304 can assist an organization in the management of maintenance in one or more of its facilities. For example, maintenance management system 304 can be used in connection with a mobile computing device that can be used to capture images of assets (e.g., indicative of a condition of the asset), provide input to a user interface to request maintenance, prompt a user to capture an image of an asset, prompt a user to provide input specifying details of the service to be performed, present a ranked list of service providers capable of performing requested maintenance, and receive updates about the service as it is performed.

In some configurations, server 302, and/or maintenance management system 304 can receive a request to initiate a maintenance request, receive details of the service request via a user interface, transmit a ranked list of service providers capable of performing the requested maintenance, receive a selection of a service provider from the ranked list, initiate the requested maintenance with the selected service provider, receive one or more images of an asset, receive input (e.g., user input), and/or any other suitable data, over a communication network 320. In some configurations, such information can be received from any suitable computing device, such as computing device 330. For example, computing device 330 can receive user input through an application being executed by computing device 330, such as through an input device (e.g., a keyboard, mouse, microphone, touchscreen, and the like). In such an example, computing device 330 can communicate information over communication network 320 to server 302 (or another server that can provide the information to server 302). As shown in FIG. 3, maintenance management system 304 can be implemented using computing device 330 and/or server 302. For example, server 302 can be used to implement at least a portion of a back-end of maintenance management system 304 and computing device 330 can be used to implement at least a portion of a front-end of maintenance management system 304.

In some configurations, server 302 can communicate with one or more computing devices, such as a one or more database servers 310, to collect information about facilities, assets, service providers, distributors, product availability, technicians associated with service providers, and/or any other suitable information. In some configurations, database server 310 can be used (e.g., by an operator and/or regional facility) to manage information used to initiate requested service. For example, database server 310 can be used to manage a database 312 (e.g., asset DB 204, corporate DB 206, customer DB 208, resident DB 210, contractor DB 212, vendor DBs 214, real-time data source 230, etc.) that includes any suitable information.

In some configurations, server 302 can communicate with one or more database servers 310 to collect information that can be used to automatically manage maintenance at one or more facilities. In some configurations, server 302 can collect information about various assets into a single database (e.g., asset database 204 described above in connection with FIG. 2A). In some configurations, computing device 330 can communicate with server 302 and/or database server 310 to retrieve information about a particular asset or type of asset. For example, computing device 330 can be used to present a user interface that can be used to initiate a request to server 302 related to one or more assets associated with a particular unit in a facility, such as a date when a particular asset was installed, a date when a particular asset was last repaired, information about a repair that was made, and any other suitable information.

In some configurations, communication network 320 can be any suitable communication network or combination of communication networks. For example, communication network 320 can include a Wi-Fi network (which can include one or more wireless routers, one or more switches, and the like), a peer-to-peer network (e.g., a Bluetooth network), a cellular network (e.g., a 3G network, a 4G network, a 5G network, etc., complying with any suitable standard(s), such as CDMA, GSM, LTE, LTE Advanced, WiMAX, 5G NR, etc.), a wired network, etc. In some configurations, communication network 320 can be a local area network (LAN), a wide area network (WAN), a public network (e.g., the Internet, which may be part of a WAN and/or LAN), a private or semi-private network (e.g., a corporate or university intranet), any other suitable type of network, or any suitable combination of networks. Communications links shown in FIG. 3 can each be any suitable communications link or combination of communications links, such as wired links, fiber optic links, Wi-Fi links, Bluetooth links, cellular links, and the like. In some configurations, server 302 and/or computing device 330 can be any suitable computing device or combination of devices, such as a desktop computer, a laptop computer, a smartphone, a tablet computer, a wearable computer, a server computer, a virtual machine being executed by a physical computing device, one or more containers executed by a computing device (e.g., a virtual machine, a physical computing device, etc.), etc.

In some configurations, communications transmitted over communication network 320 and/or communication links shown in FIG. 3 can be secured using any suitable technique or combination of techniques. For example, in some configurations, communications transmitted to and/or from server 302, computing device 330, and/or database server 310 can be encrypted using any suitable technique or combination of techniques. For example, communication between two or more computing devices associated with communication network 320 (e.g., server 302, computing device 330, database server 310, Domain Name System (DNS) servers, one or more intermediate nodes that serve as links between two or more other devices, such as switches, bridges, routers, modems, wireless access points, and the like) computing devices can be carried out based on Hypertext Transfer Protocol Secure (HTTPS). As another example, communications can be carried out based on Transport Layer Security (TLS) protocols and/or Secure Sockets Layer (SSL) protocols. As yet another example, communications can be carried out based on Internet Protocol Security (IPsec) protocols. As still another example, a virtual private network (VPN) connection can be established between one or more computing devices associated with computing network 320. In some configurations, one or more techniques can be used to limit access to communication network 320 and/or a portion of communication network 320. For example, computing devices attempting to connect to the network and/or transmit communications using the network can be required to provide credentials (e.g., a username, a password, a hardware-based security token, a software-based security token, a one-time code, any other suitable credentials, or any suitable combination of credentials).

In some configurations, one or more security techniques can be applied to any suitable portion of a communication network that interacts with computing devices. For example, security techniques can be used to implement a secure Wi-Fi network (which can include one or more wireless routers, one or more switches, and the like), a secure peer-to-peer network (e.g., a Bluetooth network), a secure cellular network (e.g., a 3G network, a 4G network, a 5G network, and the like, complying with any suitable standard(s), such as CDMA, GSM, LTE, LTE Advanced, WiMAX, 5G NR, and the like), and the like.

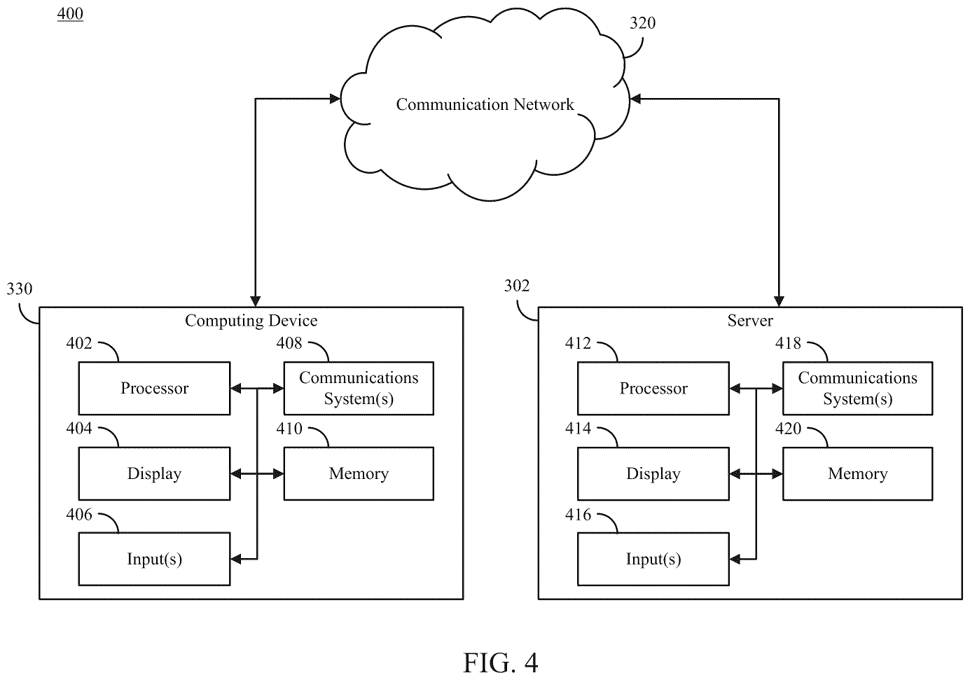

FIG. 4 shows an example 400 of hardware that can be used to implement server 302 and computing device 330 in accordance with some configurations of the disclosed subject matter. As shown in FIG. 4, in some configurations, computing device 330 can include a processor 402, a display 404, one or more inputs 406, one or more communication systems 408, and/or memory 410. In some configurations, processor 402 can be any suitable hardware processor or combination of processors, such as a central processing unit (CPU), a graphics processing unit (GPU), an accelerated processing unit (APU), etc. In some configurations, display 404 can include any suitable display devices, such as a computer monitor, a touchscreen, a television, and the like. In some configurations, inputs 406 can include any suitable input devices and/or sensors that can be used to receive user input, such as a keyboard, a mouse, a touchscreen, a microphone, a camera, etc.

In some configurations, communications systems 408 can include any suitable hardware, firmware, and/or software for communicating information over communication network 320 and/or any other suitable communication networks. For example, communications systems 408 can include one or more transceivers, one or more communication chips and/or chip sets, and the like. In a more particular example, communications systems 408 can include hardware, firmware and/or software that can be used to establish a Wi-Fi connection, a Bluetooth connection, a cellular connection, an Ethernet connection, and the like.

In some configurations, memory 410 can include any suitable storage device or devices that can be used to store instructions, values, and the like, that can be used, for example, by processor 402 to present content using display 404, to communicate with server 302 via communications system(s) 408, etc. Memory 410 can include any suitable volatile memory, non-volatile memory, storage, or any suitable combination thereof. For example, memory 410 can include RAM, ROM, EEPROM, one or more flash drives, one or more hard disks, one or more solid state drives, one or more optical drives, and the like. In some configurations, memory 410 can have encoded thereon a computer program for controlling operation of computing device 330. In such configurations, processor 302 can execute at least a portion of the computer program to present content (e.g., user interfaces, tables, graphics, and the like), receive content from server 302, transmit information to server 302, etc. In some configurations, computing device 330 can include one or more devices that can be used to determine a location of computing device 330, such as one or more satellite navigation receivers (e.g., one or more global positioning system (GPS) receivers), a cellular transceiver that can be used to determine a location of computing device 330 using locations of cellular base stations (e.g., using multilateration techniques).

In some configurations, server 302 can be implemented using one or more servers 302 (e.g., functions described as being performed by server 302 can be performed by multiple servers acting in concert) that can include a processor 412, a display 414, one or more inputs 416, one or more communications systems 418, and/or memory 420. In some configurations, processor 412 can be any suitable hardware processor or combination of processors, such as a CPU, a GPU, an APU, etc. In some configurations, display 414 can include any suitable display devices, such as a computer monitor, a touchscreen, a television, etc. In some configurations, inputs 416 can include any suitable input devices and/or sensors that can be used to receive user input, such as a keyboard, a mouse, a touchscreen, a microphone, and the like. In some configurations, server 302 can be a mobile device.

In some configurations, communications systems 418 can include any suitable hardware, firmware, and/or software for communicating information over communication network 320 and/or any other suitable communication networks. For example, communications systems 418 can include one or more transceivers, one or more communication chips and/or chip sets, etc. In a more particular example, communications systems 418 can include hardware, firmware and/or software that can be used to establish a Wi-Fi connection, a Bluetooth connection, a cellular connection, an Ethernet connection, etc.

In some configurations, memory 420 can include any suitable storage device or devices that can be used to store instructions, values, and the like, that can be used, for example, by processor 412 to present content using display 414, to communicate with one or more computing devices 330, etc. Memory 420 can include any suitable volatile memory, non-volatile memory, storage, or any suitable combination thereof. For example, memory 420 can include RAM, ROM, EEPROM, one or more flash drives, one or more hard disks, one or more solid state drives, one or more optical drives, and the like. In some configurations, memory 420 can have encoded thereon a server program for controlling operation of server 302. In such configurations, processor 412 can execute at least a portion of the server program to transmit information and/or content (e.g., results of a database query, a portion of a user interface, textual information, graphics, etc.) to one or more computing devices 330, receive information and/or content from one or more computing devices 330, receive instructions from one or more devices (e.g., a personal computer, a laptop computer, a tablet computer, a smartphone, etc.), etc.

FIG. 5 shows an example of a process for automatically managing maintenance at a facility in accordance with some configurations of the disclosed subject matter.

At 502, process 500 can receive a request for maintenance to a particular asset at a particular facility. In some configurations, process 500 can receive an indication that a particular user interface element has been selected via a user interface presented by a computing device associated with a user (e.g., via the user logging into an application executed by the computing device, by the user logging into the computing device, via the user calling or otherwise contacting an internal user of a maintenance management system, etc.). For example, selection of a particular user interface (e.g., a “new request” user interface element) can cause the computing device to transmit an indication (e.g., via a JavaScript Object Notation (JSON) message, a hyper-text markup language (HTML) message, etc.) that the user interface element has been selected. In some configurations, process 500 can receive the indication at 502.

In some configurations, for example as described below in connection with FIG. 6 and FIGS. 9A-9G, a user can initiate a maintenance request, and can provide information indicative of a scope of the maintenance request (e.g., a service category, coverage area, additional details, etc.). For example, a user can initiate a maintenance request and/or provide details (e.g., either directly through a webpage or mobile application, or indirectly via a call or other communication with an internal user). In some configurations, data received at 502 can be stored in a request database associated with a system executing process 500.

In some configurations, process 500 can receive, in connection with the request at 502, can include reception of an indication of an urgency of the request. Additionally or alternatively, in some configurations, process 500 can automatically determine and recommend an urgency of the request based on a category and other information (e.g., asset information, such as asset type, age, repair status, criticality of equipment, location within facility, scope/number of residents affected, etc.), and/or external data (e.g., weather data, season data based on facility location, EMR data for facility, etc.). For example, external data can indicate that a request is more critical in some situations but not others (e.g., repairing cooling equipment may only be urgent during summer or a heat wave). As another example, a request can be critical if the location of the equipment is in a resident room, but not if the equipment is in a hallway or other shared space. As yet another example, a request may be less critical if a room is currently unoccupied and/or, as a further example, if sufficient replacement or backup equipment or supplies are available. As still another example, a request may be less critical if process 500 determines that the facility has access to backup equipment (e.g., a temporary alternative to the asset) and/or supplies. In such an example, a recommendation for using backup equipment and/or supplies, and/or a recommendation to indicate the request is of lower criticality prompting the user to change their urgency selection. In some configurations, process 500 recommending an appropriate request urgency can lower cost for a customer and not overburden service providers when requests are less urgent, thereby increasing a health of a local service provider network. Additionally or alternatively, process 500 recommending an appropriate request urgency can improve regulatory compliance and/or resident satisfaction when requests are more urgent.

In some configurations, process 500 can solicit additional information that can be used to determine an urgency of the request (e.g., as described below in connection with FIG. 9E).

At 504, process 500 can identify service providers capable of performing the requested maintenance based on service provider capabilities and a location of the facility (e.g., by comparing a location of a facility to a coverage area of a service provider). In some configurations, process 500 can use any suitable technique or combination of techniques to identify service providers. For example, process 500 can identify service providers using techniques described below in connection with process 700 of FIG. 7.

In some configurations, process 500 can pull data for service provider capabilities and other requirements (e.g., service category) data from a database(s) of service provider information.

At 506, process 500 can filter service providers based on requirements associated with the request. For example, process 500 can remove service providers that cannot perform the requested service. As another example, process 500 can remove service providers that do not meet one or more requirements associated with the facility, operator, and/or regulatory requirements (e.g., a vaccination requirement, a licensing requirement, etc.).

At 508, process 500 can calculate provider scores based on service provider suitability to fulfill the particular maintenance request and past provider performance using any suitable technique or combination of techniques. For example, process 500 can use techniques described below in connection with 704 of FIG. 7.

At 510, process 500 can adjust an order in which to present the service providers from a ranked order based on a score associated with each service providers. For example, process 500 can present a service provider that is not a top-ranked service provider as a first service provider in a ranked list presented to a user and/or as a recommended service provider. This can improve a health of a local service provider network by directing service requests to a greater number of service providers than if a top-ranked service provider were always presented as the first and/or recommended service provider. In some configurations, process 500 can be omitted.

At 512, process 500 can cause a ranked list of service providers, which can include one or more recommended service providers, suitable to complete the maintenance request to be presented to a user (e.g., a user that caused the request to be initiated at 502). In some configurations, process 500 can use any suitable technique or combination of techniques to cause the ranked list to be presented. For example, information that can be used to present a ranked list of service providers can be transmitted to a computing device to cause the computing device to present the ranked list of service providers (e.g., via one or more JSON messages, via one or more HTML messages, etc.).

At 514, process 500 can receive an indication that a particular service provider has been selected to complete the maintenance request received at 502. In some configurations, process 500 can receive an indication that a particular user interface element associated with a particular service provider has been selected via a user interface presented by a computing device associated with the user. For example, selection of a particular user interface (e.g., associated with a particular service provider) can cause the computing device to transmit an indication (e.g., via a JSON message, an HTML message, etc.) that the user interface element has been selected. In some configurations, process 500 can receive the indication at 514. In some configurations, process 500 can record the selection by the user, which can be used, for example, to adjust weighting of customer preferences (e.g., using a machine learning model), to indicate whether a service provider has been recently selected when a next request is initiated, etc. In some configurations, process 500 can record any suitable information related to a selection by the user, such as: a position of the selection in the list; the displayed metric(s), such as response time, quality, cost rate, tags (e.g., recommended, last used, corporate preferred, etc.); etc. Additionally, in some configurations, process 500 can record any suitable information related to a service provider(s) that was not selected by the user (e.g., corresponding data associated with the service providers not selected). Such information can be used to determine whether a particular user (and/or users associated with a particular facility or operator) is often or always selecting a particular position in the list (e.g., the first position), or for a particular revealed preference(s), such as a lowest cost service provider, a service provider associated with a “last used” tag, a service provider associated with a fastest response time, a service provider associated with a highest quality, a service provider associated with a “corporate recommended” tag, etc., or some combination of preferences. In some configurations, process 500 can perform a similar determination for selection of other options and inputs (e.g., process 500 can determine whether a user/facility/operator is often or always selecting higher urgency, and can respond accordingly, such as recommending a lower urgency).

In some configurations, process 500 can determine if approval is required based on the facility and/or organization associated with the facility (e.g., based on a not-to-exceed cost limit associated with the facility, organization, etc.). In some configurations, approval may be waived for urgent requests. If approval is required, process 500 can cause an alert to be provided to an administrative user (e.g., associated with an organization, a property owner, etc.) that requests approval of the maintenance.

At 516, process 500 can facilitate scheduling of service by the selected service provider, using any suitable technique or combination of techniques. In some configurations, process 500 can cause a notification to be provided to the selected service provider with details of the request (e.g., a work description) via an electronic communication (e.g., email, text message, a push notification via an application executed by a computing device associated with the service provider, such as a mobile application or a web application). Alternatively, in some configurations, process 500 can cause an internal user to call the service provider to schedule the service.

In some configurations, process 500 can cause a user interface element to be presented to the service provider to accept or decline the service request and/or can prompt a service provider to accept or decline the service request. For example, process 500 can cause a user interface element to be presented in a user interface presented by an application executed by the computing device associated with the service provider (e.g., a mobile application or a web application). As another example, an email transmitted to service provider can cause an email client to present a user interface element(s) that the service provider can use to accept or decline the service request. As still another example, a text message transmitted to the service provider can prompt the service provider to accept or decline the service request by responding to the text message with an appropriate response (e.g., a “Y” or “YES” to accept, an “N” or “NO” to decline, etc.).

In some configurations, process 500 can provide a time limit within which the service provider can accept the maintenance request, and upon expiration of the time, process 500 can determine that the service provider declined the maintenance request. In some configurations, the time limit can vary depending on the nature of the service request (e.g., an urgent request can be associated with a shorter time limit).

In some configurations, if the service provider accepts the request, process 500 can cause a time to start the clock for determining a response time for the service request. In some configurations, if the service provider declines the service request, process 500 can update a decline rate associated with the service provider. The decline rate can be associated with the information presented to the service provider in the request to determine trends used to adjust the service providers preferences as described in more detail below. As will be further described below, the acceptance or decline rate or other information associated with acceptance or declines may be stored and aggregated, such as the information provided with the service request. For example, one non-limiting example of such additional information provided with the service request will be described with respect to FIG. 9J.

If process 500 determines that the service provider declined or otherwise did not accept the maintenance request (“NO” at 518), process 500 can return to 512. Note that, in some configurations, if the service request is particularly important (e.g., the service request is related to a critical emergency), process 500 can automatically select a different service provider (e.g., a highest ranked service provider other than a previously selected service provider) without user input (e.g., due to the emergency nature of the request), and can facilitate scheduling of the service with the automatically selected service provider.

Otherwise, if process 500 determines that the service provider accepted the maintenance request (“YES” at 518), process 500 can move to 520.

At 520, process 500 can receive updates as the maintenance service is performed and/or completed using any suitable technique or combination of techniques. For example, in some configurations, process 500 can prompt a technician dispatched to perform the service associated with the request to provide feedback indicative of a progress of the maintenance request.

For example, in some configurations, after arriving on-site at the facility, a service technician can check-in (e.g., via a user interface of an application, such as a web application or a mobile application, via a telephone call to a particular phone number). In some configurations, checking in can stop a timer that determines a “response time” for the job. In some configurations, the response time can be recorded and used to determine a response time score. In some configurations, the service provider (e.g., via a technician) indicating check-in can also trigger a notification to a customer/facility user and displayed via a user interface (e.g., via a web/mobile application) providing a check-in time and user interface elements to “confirm” that the service technician(s) arrived at the indicated time or “report” that they did not.

In some configurations, if the service provider completes the service the same day that the technician checked in at the facility, the service provider can indicate (e.g., via checking out) that the service has been completed (e.g., via a user interface of an application, such as a web application or a mobile application, via a telephone call to a particular phone number). Additionally or alternatively, if the service provider does not complete the service the same day that the technician checked in at the facility, the service provider can indicate (e.g., via checking out) that the service technician has left for the day, and that the service has not yet been completed (e.g., via the user interface, via a telephone call to a particular phone number). For example, process 500 can prompt a user to indicate whether work on the maintenance request has been completed upon checking out, or whether the service provider needs to return to perform additional work.

In some configurations, process 500 can record whether or not the work was completed during a single visit, or whether after completing the initial work the service provider needed to return to perform additional work. Process 500 can update a “first-time-fix” rate for the service provider based on whether the work was completed during a single visit and/or within a single day (e.g., a first check-in by the technician and an indication that the work is complete falls within a single day).

In some configurations, process 500 can receive updated asset information associated with completion of the maintenance. For example, process 500 can receive (e.g., from a computing device associated with a technician completing the maintenance) identifying information associated with a new and/or repaired asset, and/or an image(s) of the new and/or repaired asset (e.g., an image of a replacement part). As a more particular example, identifying information of a new asset (e.g., via replacement of an existing asset, or a new installation) can include a serial number, another identification number, a QR code associated with the asset, etc. As another more particular example, an indication that the existing asset was repaired (e.g., including an indication of which parts, if any, were serviced and/or replaced) can be provided, and the date the service was completed and/or information about the service that was performed can be provided at 520. In some configurations, process 500 can use such updated asset information to update asset database 204.

At 522, process 500 can receive feedback from a user associated with the facility regarding performance of the service.

In some configurations, once work is indicated as completed, process 500 can cause a notification to be sent to a customer/facility user and displayed via a user interface (e.g., via a web/mobile application) providing an indication that the work was completed, and allow the customer/facility user to rate the service provider with a rating (e.g., an overall star rating out of five stars, a rating out of five starts for various categories, such as speed, value, professionalism, etc.) and/or comments, or an opportunity to report that the work has not been completed.

In some configurations, if process 500 determines that a customer rating (e.g., an overall rating, an average of ratings for multiple categories, etc.) is below a threshold (e.g., a rating in a range of 1-3 stars out of 5 starts), process 500 can cause an alert to be generated and sent to an administrative user associated with the service provider including the score and/or a comment, so that the issue that caused the low rating can potentially be addressed.

At 524, process 500 can update information about service provider performance. In some configurations, process 500 can use any suitable technique or combination of techniques to update the information. For example, process 500 can update information such as response time, time to completion (e.g., from a time that a request was sent to the service provider, from a time that the request was presented to the service provider, or from a time that a request was accepted by the service provider), a number of trips required for completion of the service request, a rating, comments, etc.

FIG. 6 shows an example of a process for automatically receiving a request for maintenance associated with an asset at a facility in accordance with some configurations of the disclosed subject matter.

At 602, process 600 can receive an indication, from a user device, to initiate a service request using any suitable technique or combination of techniques, such as techniques described above in connection with 502 of FIG. 5 and as described below in connection with FIGS. 9A-9G.

At 604, process 600 can receive an indication of relative weights to apply to different aspects of service provider performance. For example, process 600 can receive input indicative of which of multiple aspects of service provider performance are relatively more important to the user, such as speed, quality, price, etc. In a more particular example, process 600 can receive input to a multi-dimensional slider of a user-interface element (e.g., a triangular user interface element with a slide that can be placed in any position within the triangular user interface element) for controlling the relative weight of attributes shown with a slider node in multiple positions to adjust the relative weights of the attributes. In some configurations, process 600 can omit 604.

At 606, process 600 can receive input indicative of a type of service(s) that is needed using any suitable technique or combination of techniques. For example, process 600 can receive input indicative of what type of service is needed (e.g., as described below in connection with FIG. 9B), and/or for what type of asset service is needed.

In some configurations, process 600 can cause a user to be prompted to provide answers to clarifying questions on the scope of their service request that improves a likelihood that the correct service category is selected, needed capabilities are understood, and/or available service provider options are filtered to those offering the needed services.

At 608, process 600 can receive an indication of an urgency of the service(s) and/or cost expectations via a user interface. For example, process 600 can receive input indicative of an urgency of the request (e.g., as described below in connection with FIGS. 9D and 9E). In some configurations, process 600 can prompt a user to specify a particular service level expectation (e.g., a particular number of hours within which service is requested) in addition to, or in lieu of, prompting a user to select from existing P1, P2, and P3 turnaround expectations.

At 610, process 600 can receive an indication of whether the requested service is to repair an existing asset, replace an existing asset, and/or installation of a new asset. For example, process 600 can receive input indicative of whether the request is for repair, replacement, or installation of an asset (e.g., as described below in connection with FIG. 9F).

At 612, process 600 can prompt a user for additional information regarding the service request using any suitable technique or combination of techniques. For example, process 600 can prompt a user to answer a particular targeted question(s) based on previous information (e.g., as described below in connection with FIG. 9G).

At 614, process 600 can receive confirmation of contact details and expectation for when service dispatch is to be initiated using any suitable technique or combination of techniques. For example, process 600 can prompt a user to provide and/or confirm contact details and/or confirm when service dispatch is to be confirmed (e.g., as described below in connection with FIG. 9H).

FIG. 7 shows an example of a process for automatically identifying and recommending appropriate service providers to respond to a request for maintenance associated with an asset at a facility in accordance with some configurations of the disclosed subject matter.

At 702, process 700 can identify service providers that cover the facility associated with the service request and that are capable of performing the requested service using any suitable technique or combination of techniques. For example, process 700 can query a database (e.g., contractor DB 212) using information associated with the request, such as a location of the facility (e.g., an address, a zip code, a zip+4, a census tract, etc.) and an indication of what type of service is requested (e.g., details of an asset, details of the service to be performed, etc.). In some configurations, identifying service providers at 702 can include a comparison between the facility location and covered locations by each service provider (e.g., covered geographic areas, ZIP codes, addresses, and/or distance/travel-time from service provider dispatch) to determine whether the facility falls within a covered area for that service provider. In some configurations, the coverage area can be based on predetermined configurations (e.g., selected ZIP codes), can be determined and/or modified automatically based on various factors (e.g., decline rates) as described below in connection with 704 of FIG. 7, or using a combination of both (e.g., adjusting a predetermined coverage area configuration based on decline rates). In some configurations, initial capabilities, categories, and/or services associated with a service provider can be based on predetermined configurations, can be automatically determined and/or modified based on various factors (e.g., including decline rates) as described below in connection with 704 of FIG. 7, or using a combination of both (e.g., adjusting predetermined capability configurations based on decline rates).

In some configurations, process 700 can receive identifying information of service providers that are capable of performing the requested service. In some configurations, process 700 can filter the service providers to remove and/or down-weight service providers that do not meet the capabilities and requirements associated with the facility and/or service request. For example, process 700 can filter or weight the service providers based on localization and/or response times to facilities in an area near the facility. For example, process 700 can remove and/or down-weight service providers that are unlikely to provide a relatively fast response time. In some configurations, process 700 can determine a likely response time based on a real-time (or near real-time) location of one or more technicians capable of performing the service, and a likely travel time to the facility location.

In some configurations, process 700 can filter the service providers to remove and/or down-weight service providers based on urgency requirements associated with the service request. For example, process 700 can filter out service providers that have indicated that they do not perform urgent services when the service is indicated as being a particular urgency.

In some configurations, process 700 can filter the service providers to remove and/or down-weight service providers based on whether the service provider complies with a user requirement (e.g., a vaccination requirement, a licensing requirement, etc.).

In some configurations, process 700 can filter the service providers to remove and/or down-weight service providers that are predicted to be unavailable for requests. For example, process 700 can predict a particular service provider's availability based on decline rates by a particular service provider (and/or similar service providers, e.g., determined by clustering service providers based on past decline rates) at similar times of day, on similar days of the week, on similar dates in the past, etc.

At 704, process 700 can calculate a performance metric (e.g., a score) for each of the identified service providers based on information associated with the service request using any suitable technique or combination of techniques. For example, process 700 can calculate a score for each service provider for each of multiple metrics, such as a speed, price, ease of use, first time fix rate, five-star rating, etc., such as techniques described below in connection with TABLE 1, and FIGS. 10 and 11.

In some configurations, process 700 can calculate provider fitness scores for each of the service providers (e.g., unsorted service providers) using any suitable scoring system, by calculating a score for one or more factors (e.g., multiple factors).

In some configurations, process 700 can calculate a score for each factor using data localization. For example, process 700 can calculate scores based on performance of the service provider using a community/facility level (e.g., based on performance at the facility at which service is requested), at a ZIP code level, at a market area (e.g., a city level, a metropolitan area, etc.), at a global level, etc. In some configurations, calculating scores based on localized performance can give more weight to data closer to the facility. For example, scores can be weighted based on similar actual distance or travel time. Additionally or alternatively, more weight can be given in ascending order to data at the facility level, ZIP code level, market level, global level, etc.

In some configurations, process 700 can change scoring weights for each factor before combining to obtain a provider fitness score. For example, process 700 can change scoring weights based on set customer preferences, and/or customer preferences determined using a machine learning model based on prior selections.

In some configurations, process 700 can account for a rate at which a service provider declines requested service (e.g., negatively adjusting a score based on a relatively high decline rate compared to other similar service providers in the market, such as a threshold amount over an average rate).

In some configurations, process 700 can determine a score based on service provider quality. For example, process 700 can utilize a first time fix rate component of a quality attribute, which can be calculated based on a rate that a service provider is able to complete a service request in one trip. In some configurations, a rate less than a threshold percentage can result in a negative value that subtracts from the total score for a service provider.

As another example, process 700 can utilize a five-star rating component of a quality attribute, which can be calculated based on an average five-star community rating submitted by customers after a service completion.

In some configurations, a poor rating in quality can subtract from an overall score, as process 700 can utilize a baseline level of quality. In such configurations, only an above average quality score can add to an overall score for a service provider.

In some configurations, process 700 can determine a score based on service provider speed. For example, process 700 can determine a speed attribute based on response time, which can depend on an urgency level. In such an example, for urgent requests (e.g., P1 and P2 requests), process 700 can use a linear score system where a less than 2 hour response time for P1 requests and a less than 5 hour response time for P2 requests can provide the most points and 6 hour response times for P1 and 12 hour response times for P2 can receive zero points. The response time is determined from when the service provider accepts the service request until the service provider technician checks-in at the facility of the customer. A baseline score can be given for the speed attribute if there is not enough or no urgent service request data for a service provider. For non-urgent requests (e.g., P3 request) the score for the speed attribute can be based on the percentage of service request tickets that the service provider is able to check in or deliver the service within 24 hours (e.g., the same or next business day). This can be a linear score system where 100% requests completed within 24 hours gives max points and 0% gives 0 points. Alternatively, although 100% within 24 hours may give less than max and negative points may be possible.

In some configurations, process 700 can determine the speed attribute for a particular service provider based on past response times to the facility associated with the service request, response times to other nearby facilities (e.g., within the same ZIP code; located within a predetermined travel time and/or distance from the facility; etc.), and/or response times to all facilities within the service provider's market. For example, if a sufficient number of response times to the facility for that particular service provider are available (e.g., at least X response times within the past Y months), process 700 can use response times for the particular service provider to the facility to calculate the speed attribute. As another example, process 700 can use response times to nearby facilities (which may or may not be affiliated with the facility) when calculating the speed attribute. In such an example, process 700 can use response times to the nearby facilities in addition to, or in lieu of, response times to the facility (e.g., using a non-weighted average, or a weighted average in which response times to the facility and/or more recent response times are weighted more heavily).

In some configurations, process 700 can determine a speed attribute for all service events for a specific service provider or more granularly for specific areas (e.g., by ZIP code). This can be a proxy for proximity of a service provider to a facility. Additionally or alternatively, in some configurations, real-time availability and speed can be used to adjust the speed attribute. Such real-time availability can include traffic data or projected response time based on historical traffic data.

In some configurations, process 700 can adjust a speed attribute based on whether a service provider has all necessary supplies/parts in order to perform a service (e.g., by querying an inventory database of available supplies/parts associated with the service provider and comparing with required supplies/parts to perform a particular service). If supplies need to be purchased, process 700 can take into account how long it is likely to take to have part shipped or picked up from a service provider warehouse or purchased from a store. In some configurations, process 700 can determine a speed attribute based at least in part on a schedule and availability of the service provider, which can be general availability and/or availability of a particular technician or technicians that are capable of performing the maintenance. In some configurations, determining some or all necessary supplies/parts needed in order to perform a service are unavailable in an inventory of a service provider may be used to filter out service providers. Alternatively, determining that all necessary supplies/parts needed in order to perform a service are available in the inventory of the service provider may be used to positively adjust the speed attribute of the service provider; however, if the inventory level is unknown there may be no effect on the speed attribute.

In some configurations, process 700 can determine a score based on service provider price. In some configurations, process 700 can determine a price attribute that is linearly scored based on price relative to other service providers, in which a lowest price can receive a maximum or near maximum number of points, and a highest price can receive a worst score (which can, e.g., be negative). In some configurations, a price attribute can differ between urgent and non-urgent requests in that a price can be given less relative weight (e.g., in an overall score) for urgent requests compared to a speed attribute, whereas for non-urgent requests a price attribute can be given more weight.

In some configurations, the price attribute can be based on an hourly rate for a service provider for a specific category of services (e.g., standard plumbing rate). Additionally or alternatively, in some configurations, a price attribute score can be determined based on a true or real cost projection. This can be done using invoice data to determine an effective hourly rate to account for service providers who take longer to complete jobs and service providers that bring more than one technician to a job (e.g., a lower efficiency service provider).

In some configurations, process 700 can determine a score based on service provider ease-of-use. For example, for a service category, process 700 can determine a linearly increasing score for a service provider relative to other service providers within a ZIP code based on a total number of service requests. A most used service provider can receive a maximum or near maximum points, while a least used service provider can receive a least number of points (or negative points).

In some configurations, process 700 can include an ease-of-use attribute for only non-urgent requests, and speed can be given more weight than price for urgent requests compared to non-urgent requests.

In some configurations, process 700 can determine scores using data for a specific customer (e.g., a particular community/facility/organization) if there is a certain level of usage by a customer with a service provider (e.g., at least a threshold level of usage, such as at least 3 uses, at least 5 uses, etc., which can also differ for urgent and non-urgent requests). In such a configuration, if there is not enough data for a specific customer for a specific service provider, the data included can be broadened to include data for that service provider for the ZIP code in which the facility is located. If not enough data exists for that ZIP code, then the data from that service provider can be broadened to include data for the market (e.g., a coverage area, which can include nearby ZIP codes). If not enough data exists for that market (or coverage area), the data can be broadened to include regional and/or national for the service provider. Calculating the score based on the same or nearby ZIPs can help provide more accurate scoring for that facility, as one service provider may be better at serving a particular ZIP code(s) or area than another. As an alternative, a comparison between a location (e.g., based on GPS data) of a dispatch location of the service provider and a location of the customer facility can be used, and service provider performance within a threshold of that distance can be used (e.g., if enough data exists). In some configurations, process 700 can be based on distance (and/or travel time) between the service provider location and the facility. In some configurations, scores can be calculated based on facilities that are in a similar area, or a similar distance from the location of the service provider (e.g., the same weight can be given to data for requests from another facility with a location at similar distance and/or travel time from a location of the service provider regardless of whether the other facility is near the customer making the new service request). Additionally or alternatively, all data for a service provider can be used, and more weight can be applied to data nearer the requesting facility. The weight can decrease (e.g., linearly, exponentially) the further away the facility is from the requesting facility. For example, this can be based on actual distance, based on travel time, and/or ZIP codes.

In some configurations, localization can depend on which factor is being scored (e.g., as described below in connection with TABLE 1).

In some configurations, process 700 can use data from a certain time frame to determine scores at 704 and/or can down-weight older data (e.g., based on how far outside the time frame the data falls). For example, process 700 can use data from the past 6 months (or 180 days). This can allow for bad scores (or good scores) to fall-off. In such an example, removing or down-weighting data from outside of the certain time frame can allow service providers to improve the service providers score with potentially improved performance in recent history, or decrease scores for service providers with worse recent performance. The time frame used can vary for each attribute. Additionally or alternatively, process 700 can weigh historical data based on time (e.g., linear or exponential down-weighting based on time) such that more weight is given to more recent data. This can help to account for more recent behavior or service providers.

In some configurations, if there is not enough data for a new service provider for an attribute, process 700 can utilize an average value to get up to a minimum number of data points required to calculate the score (e.g., 5 or 10 data points). For example, for a star quality rating component (e.g., of the quality attribute), a particular value (e.g., 4.75 out of 5, or some other above average score for all service providers or service providers in that area) can be used when not enough data is available to get up to a minimum number of data points (e.g., 5, 10, etc.). In such an example, the quality score can be calculated from the existing data and the plugged-in values. Additionally or alternatively, if not enough values exist for an attribute (e.g., not at least a threshold number), but do exist for another attribute, the attribute where there are no values can be excluded and the score can be normalized based on a maximum possible score, less the possible points for the excluded attribute(s) (e.g., dividing by the new maximum score excluding the attribute). This can improve a service provider network health by propping up new service providers (and/or service providers that have had a drop in scored work such that enough data points have dropped off due to time) so that such service providers can get more work, which can facilitate gathering performance data on the new service provider (e.g., in particular performance data that is accurate and up to date), and establish a score based on real data points.

In some configurations, process 700 can account for decline rates by a service provider. For example, process 700 can adjust a score for a service provider that has more than a threshold level of declines (e.g., by subtracting from that service provider's score). This can be a linearly decreasing value to a certain point based on relative decline rate compared to other service providers (e.g., generally and/or for specific area(s)). Decline rates can also be correlated for each service provider with different service categories, different asset and/or job details, different service provider capabilities, time, days, service areas, facilities (e.g., locations or distance from dispatch location), type of work (e.g., repair, replace, inspection, maintenance, etc.), and/or other suitable data, to make predictions for when or for what reason a particular service provider (or service providers generally) are likely to decline a request. In some configurations, process 700 can adjust a score when a similar situation applies (e.g., if a customer is often declined by a particular service provider, or the customer is a certain distance away or is in an area that a service provider typically declines, customer is requesting specific work that is often declined, etc.). Additionally or alternatively, process 700 can make a recommendation against selecting a service provider with a high decline rate in this situation (e.g., rather than reducing the score for that service provider) and/or another service provider can be recommended even if the service provider with the predicted decline has a higher overall score. Additionally or alternatively, in some configurations, process 700 can update capabilities associated with a service provider that consistently declines certain types of requests in a particular area. For example, a service provider with a decline rate over a threshold, such as 50%, 75%, etc. for a particular type of request, can be updated to remove that type of request from the service providers capabilities (e.g., when identifying service providers and/or filtering out service providers at 702). As another example, process 700 can adjust the score for the service provider when a particular capability, category, and/or job detail is selected or entered.

In some configurations, process 700 can use decline rates to determine more about the capabilities and preferences of a service provider, which can be used to align service provider recommendations with customer requests (e.g., if a service provider consistently declines a particular capability or asset type), and automatically update a capability configuration of the service provider.

In some configurations, process 700 can associate decline rates with spatial data (e.g., locations, facility), which can be used to determine and/or update a coverage area of a particular service provider. For example, process 700 can update coverage area by ZIP code (e.g., by unselecting a particular ZIP code(s)), and/or by determining a coverage area regardless of ZIP code boundaries. In a more particular example, an initial coverage area can be identified based on ZIP codes, and process 700 can determine a more granular coverage area that may only cover a portion of certain ZIP codes. In such examples, process 700 can use decline rates to automatically determine coverage areas that coincide with geographic boundaries, such as “west of a particular highway”). In some configurations, decline rates can be associated with temporal data (e.g., time, date, holiday, day of week) to determine service provider preferences for time of day, day of week, day of month, dates, holidays (e.g., between 12 AM to 6 AM, weekends, holidays, etc.). As described above, in some configurations, associating decline rates can be used to improve recommendations. For example, decline rates can be used to add a service provider to, or remove the service provider from, a list of capable service providers (e.g., by automatically adjusting a service provider's configurations, such as by adjusting their availability schedule, coverage area, capabilities, etc.) in connection with a particular request. As another example, decline rates can be used to adjust a score, for requests with a capability, category, asset, job detail, area, time, day of week, work type, or any combination thereof that is often or always declined by the service provider. In some configurations, a service provider can be notified of a change to the coverage area, capability, and/or availability schedule, and can be provided with an opportunity to override, and/or request override, an automatic adjustment and/or make changes to future practices, which can provide the service provider with an opportunity to receive more requests in the future.

In some configurations, process 700 can associate decline rates with spatial data (e.g., locations, facility), which can be used to determine and/or update a coverage area of a particular service provider. For example, process 700 can update coverage area by ZIP code (e.g., by unselecting a particular ZIP code(s)), and/or by determining a coverage area regardless of ZIP code boundaries. In a more particular configuration, an initial coverage area can be identified based on ZIP codes, and process 700 can determine a more granular coverage area that may only cover a portion of certain ZIP codes. In such examples, process 700 can use decline rates to automatically determine coverage areas that coincide with geographic boundaries, such as “west of a particular highway”). In some configurations, decline rates can be associated with temporal data (e.g., time, date, holiday, day of week) to determine service provider preferences for time of day, day of week, day of month, dates, holidays (e.g., between 12 AM to 6 AM, weekends, holidays, etc.). As described above, in some configurations, associating decline rates can be used to improve recommendations. For example, decline rates can be used to add a service provider to, or remove the service provider from, a list of capable service providers (e.g., by automatically adjusting a service provider's configurations, such as by adjusting their availability schedule, coverage area, capabilities, etc.) in connection with a particular request. As another example, decline rates can be used to adjust a score, for requests with a capability, category, asset, job detail, area, time, day of week, work type, or any combination thereof that is often or always declined by the service provider. In some configurations, a service provider can be notified of a change to the coverage area, capability, and/or availability schedule, and can be provided with an opportunity to override, and/or request override, an automatic adjustment and/or make changes to future practices, which can provide the service provider with an opportunity to receive more requests in the future.

In some configurations, for example, as described below in connection with TABLE 2, process 700 can adjust a scoring system that is used depending on an urgency level that is selected by a user and/or an urgency level that is assigned to a request. For example, for urgent requests, process 700 can increase a weight of a speed attribute and decrease a weight of quality and price attributes.

In some configurations, process 700 can utilize other data to make determinations and recommendations. For example, for urgent requests, distance (or travel time) between the facility and service providers (e.g., a dispatch location of the service provider, a real-time location of the technician(s) that are likely to be dispatched) can be determined, and a recommendation or tag can be added, such as, “nearest to you.”

In some configurations, process 700 can use capability, type of work, additional details provided by the customer, and facility/asset data along with real time data (e.g., weather), to automatically determine and suggest an urgency level. For example, if a packaged terminal air conditioner (PTAC) is not working and needs repair, various data points can be used to determine if the repair is likely to be urgent, such as a location of the PTAC in facility (e.g., common room/hall, which is less urgent than a PTAC in a resident room), an outside temperature at facility exceeding a threshold, a number of potentially impacted residents exceeding a threshold, whether a space cooled by the PTAC is occupied, etc. In some configurations, data can also include data from an EMR system, an electronic medical record database (e.g., information about a resident occupying a room in which a PTAC needs repair; it can also include information regarding all residents within a facility).

In some configurations, process 700 can utilize user-specified weighting provided by a user (e.g., adjusted within a customer management user interface), which can be on a facility level, an organization level, or both. In some configurations, customizing weights can be performed using various user-interface input techniques. For example, a user interface can allow a user to rank attributes in an order of importance to the user. As another example, a user can adjust individual values for each attribute through an input mechanism (e.g., one or more sliders, such as a multi-variable slider). The value indicated by the user for each of the attributes can then be used to calculate the relative weight given to each attribute when calculating service provider scores. For example, minimum and maximum weights for each attribute can be configured by the platform provider to prevent any attribute from being given too much or too little weight.

Additionally or alternatively, in some configurations, a user-interface input mechanism for granularly setting the relative weights can be provided. A multi-dimensional (e.g., three-dimensional) slider can be provided. Such a slider can include a triangle with each point representing one of three attributes, and a slider node that can be moved within the area of the triangle can be used to indicate relative importance of each attribute. In such an example, distances between each point of the triangle and the slider node can be used to determine the relative weights of each corresponding attribute. The closer the slider node is to a point the more relative weight the attribute can be given. For example, when the slider node is in the center of the triangle, equal relative weight can be given to each of the attributes. As another example, when the slider node is located off-center such that the slider node is located closer to one or more points than to one or more other points of the triangle, more relative weight can be given to the attributes corresponding to the points of the triangle the slider node is closest to. In a more particular example, when the slider node is located closest to the point corresponding to the quality attribute, then the most relative weight can be given to the quality attribute, the next most relative weight can be given to the speed attribute based on the corresponding point being the next closest, and the least relative weight can be given to the price attribute based on the corresponding point being the furthest from the slider node. As yet another example, if the slider node is aligned a point corresponding to a single attribute then most or all relative weight can be given to that attribute.

In some configurations, relative weight control techniques for setting the relative weights of the attributes can give absolute control of the relative weights of the scoring performed by process 700, such that when a user-interface indicates equal weight for each attribute, process 700 can give equal weight to each of the attributes. Alternatively, in some configurations, relative weight control techniques for setting the relative weights of the attributes can give relative control to adjust the underlying baseline relative weights, such that when the user-interface indicates equal weight for each attribute, process 700 can give a default weight to each of the attributes. Additionally, the relative weights assigned to different attributes can be the same or different for urgent and non-urgent requests (e.g., a different user interface element can be used to control weights for urgent request than for non-urgent requests).

In some configurations, a customer can select one of multiple options to automatically adjust the weighting to provide the best recommendations to meet the customer's needs and preferences. For example, the user can select from predetermined profiles that emphasize quality, speed, or price, or some combination of those attributes.

In some configurations, process 700 can control weighting of the attributes based on a customer's revealed preferences derived from the customer's buying decisions and/or feedback on purchased services, which can potentially improve scoring to better match a customer's revealed preferences and/or needs (which may differ from the customer's expressed preferences and/or needs).

In some configurations, process 700 can use one or more machine learning models to customer weighting based on revealed preferences. In some configurations, input to the machine learning model(s) can include data for each service request transaction for a customer. This can include the service provider that a customer selected for each service request and corresponding feedback (e.g., an overall star rating, star ratings for individual categories, etc.) provided by the customer for the service request. For example, the relative weighting of attributes can be automatically adjusted for a customer when that customer repeatedly selects service providers that consistently have higher scores for one or more particular attributes (e.g., price, speed, quality, etc.). As another example, the relative weighting of attributes can be automatically adjusted based on the rating given to the service provider by the customer after a requested service has been completed, which can be used to determine what attributes the customer gives the most weight to when assessing quality of the provided service. As yet another example, the relative weighting of attributes can be automatically adjusted can use natural language processing of comments to inform a semantic meaning behind the customer rating and/or comments to help determine what attributes the customer values most and how to adjust weightings. In a more particular example, a 3-star rating along with a comment (e.g., “Service provider was late.”) can be used to automatically determine more weight should be given to speed.

In some configurations, the relative weighting of attributes can be automatically adjusted based on data for the service providers associated with a specific customer, but may be for a local market or globally across all markets. In some configurations, the machine learning model can also account for the scores of the service providers relative to other service providers within the local market or globally.

In some configurations, process 700 can use any suitable scoring system to determine a performance metric for each of the service providers. For example, as described below in TABLE 1, particular point ranges can be assigned to different attributes, which can be different for urgent and non-urgent requests.

TABLE 1

| | Urgent Request | | Non-urgent Request | |
|---|---|---|---|---|
| | Point | | Point | |
| Attribute | Range | Measurement | Range | Measurement |
| Speed | 0 to 73 | Based on P1 response time avg. | 0 to 30 | Based on the percentage of tickets |
| | | over past 6 months. If the | | where the SP can deliver service |
| | | community has had 3 or more | | within 24 hours. Based on |
| | | urgent requests with this SP over | | preliminary calculations, the |
| | | this time period, use their specific | | average SP accomplishes this 40% |
| | | performance. If instead, the market | | of the time. If the community has |
| | | has had at least 3 urgent services | | had 3 or more urgent requests with |
| | | requests, use the P1 response time | | this SP over this time period, use |
| | | for the market. In all other cases, | | their specific performance. If |
| | | use overall performance across all | | instead, the market has had at least |
| | | coverage areas. Linear scoring | | 3 urgent services requests, use the |
| | | where 2 hour expectation yields 45 | | market. In all other cases, use |
| | | points and anything greater than 6 | | overall performance across all |
| | | hours is 0 points. If SP has not had | | coverage areas. Linear scoring |
| | | a P1 request, they get 30 points. | | where 100% is 25 points, 80% is |
| | | | | 20 points, 60% is 15 points, etc. |
| Price | 0 to 21 | Linear scoring where average zip | 0 to 47 | Linear scoring where average zip |
| | | code pricing position for service | | code pricing position for service |
| | | category is 9 points, best pricing is | | category is 20 points, best pricing |
| | | 18 points, and worst is 0 points. | | is 40 points, and worst is 0 points. |
| Ease of | N/A | N/A | 0 to 12 | Looking within zip for service |
| Use | | | | category over 6 months, most used |
| | | | | gets 10 points and scales linearly |
| | | | | to 0 points for least used. |
| Quality - | −4 to 1 | Across all coverage areas for the | −4 to 2 | Across all coverage areas for the |
| First | | SP in question: | | SP in question: |
| Time Fix | | >=88% translates to 1 point; | | >=88% translates to 2 point; |
| Rate | | >=70% and <88% translates | | >=70% and <88% translates |
| | | to 0 points; | | to 0 points; |
| | | <70% translates to −4 points. | | <70% translates to −4 points. |
| Quality - | −16 to 5 | If specific community staff have | −16 to 9 | If specific community staff have |
| Five Star | | rated the SP 5 or more times, use | | rated the SP 5 or more times, use |
| Rating | | the community's ratings. Else, use | | the community's ratings. Else, use |
| | | overall ratings for the SP. | | overall ratings for the SP. |
| | | Timeframe of past 6 months. | | Timeframe of past 6 months. |
| | | >=4.6 translates to 4 points; | | >=4.6 translates to 8 points; |
| | | >=4 and <4.6 translates to 0 | | >=4 and <4.6 translates to 0 |
| | | points; | | points; |
| | | >=3.5 and <4 translates to −8 | | >=3.5 and <4 translates to −8 |
| | | points; | | points; |
| | | <3.5 translates to −16 points. | | <3.5 translates to −16 points. |

As described above in connection with FIG. 2A, in some configurations, a speed attribute can be modified using real-time location information. For example, a speed attribute for an urgent request can be an average (e.g., a weighted average) of an attribute based on past response times, and an attribute based on an estimated response time using real-time location information.

At 706, process 700 can sort the service providers based on the performance metric(s) calculated at 704. For example, after calculating service provider scores at 704 for service providers identified at 702, process 700 can sort the service providers for presentation to a user (e.g., via a customer-facing user interface, as shown in FIG. 9I).

In some configurations, the service providers can be initially sorted based on the calculated scores from highest to lowest. In some configurations, the service providers can be presented based on the initial sorting from highest to lowest scores.

At 708, in some configurations, process 700 can select a subset of service providers with performance metrics indicative of best performance, e.g., by performing additional actions to adjust an order in which service providers are presented. For example, in some configurations, process 700 can split the service providers into multiple groups (e.g., top scorers and others or bottom scorers). In such an example, the top scorers can be a set number (e.g., a top 3, a top 4, etc.) or a percentage (e.g., a top 25%, a top 33% etc.) of all service providers identified at 702 (e.g., including or excluding service providers filtered out at 702) with highest scores. Alternatively, in some configurations, the top scorers can be service providers having a score that is at least a threshold percentage of the highest score (e.g., at least 95%, at least 95%, at least 85%, a least 80%, at least 75%, etc.). In some configurations, the bottom scorers can be the service providers that are not top service providers. In some configurations, limiting the number in the top scorer group (e.g., to a top 3) can increase a salience of a high score, which can improve incentives to continue to maintain and/or improve service.

In some configurations, process 700 can randomly arrange the top scorer group, which can reduce a likelihood that all (or a large majority of) requests will go to the single best performing service provider. In some configurations, the random arrangement can be weighted based on variance in scoring, which can encourage further improvement. For example, process 700 can select higher scoring service providers at a higher rate than lower scoring service providers.

In some configurations, process 700 can select a predetermined number of service providers (e.g., 4) to present from the randomly arranged top scorers. In some configurations, after a first set of service providers (e.g., the top 4 from the randomly ordered group), the next service providers to be presented can be presented in the random order or in an order based entirely on scores. In some configurations, the number of top performers can be determined or adjusted in real-time based on the size of the display/window on the device. For example, process 700 can select a larger number of service providers for a device and/or an application window with a larger display area. Additionally or alternatively, a predetermined number of top performing service providers can be presented on a first page presented to a user, and a next set of service providers can be presented on additional pages and/or can be hidden and can be presented in response to selection of a user interface element (e.g., a “show more” user interface element).

In some configurations, process 700 can add a “recommended” tag or message to a particular service provider(s), which can be selected randomly from the top scorers being presented. Alternatively, process 700 can add the “recommended” tag or message to the service provider in the presented service providers with a best score, which can be the top overall scorer or the top scorer based on a most important attribute specific by the user. As another alternative, in some configurations, process 700 can add the “recommended” tag or message to the service provider in the presented service providers with a best score determined based on a customized or machine learning model-based weighted score, regardless of whether the initial scoring and/or sorting at 704 and 706. In some configurations, tagging providers that may not be a top overall scorer as recommended and/or not necessarily including the top overall scorer in the initial set of service providers to be presented (e.g., if the best performer is in the top scorer group, but not included in the first 4 randomly ordered service providers from the top scorer group), as always recommending the top overall performer can overburden the top performer with requests, which can cause the quality and/or speed to decrease, the price to increase, and/or the decline rate to increase, as the service provider receives more requests than can be quickly completed at high quality with its current personnel. Randomly sorting top scorers can help to distribute service volume to different service providers, which can improve service provider network health while still providing the best available options to a customer for a particular request and customer. Additionally, recommending relatively high performing service providers other than a top service provider can assist other service providers in building a service history.

At 710, process 700 can determine whether to include any new service providers (e.g., service providers that do not have a threshold number of completed service requests within a predetermined period of time, such as 6 months).

In some configurations, process 700 can incorporate new service providers into the top scorers group to give the new service providers a chance to get jobs and build up history and data (e.g., incorporating such new service providers can facilitate gathering data on the new service providers). In some configurations, process 700 can insert dummy data scores based on an average (e.g., which can be relative) for a factor for which not enough data exists, the dummy data can then be averaged with actual data to determine a score and fitness for that service provider. As actual data is gathered the dummy data can be replaced to obtain a more accurate actual score.

In some configurations, a new service provider can be one without any data or without enough data (e.g., 3, 5, 10 data points). In some configurations, a service provider can also be considered new whenever existing service request data within a time limit (e.g., a past 6 months) falls offs below a threshold.

In some configurations, after being selected and/or completing a predetermined number of jobs (e.g., within a time-frame, such as 3 months, 6 months, etc.), a service provider can be removed from the new category, such that the service provider's score must hold-up on its own to continue being included in the top scorer group. In some configurations, the predetermined number of jobs can be an absolute number or can be relative to other service providers being scored and sorted for the service request. In some configurations, process 700 can use techniques described in connection with 710 to boost new providers and prop them up until they get enough work and corresponding data that they can stand on their own and can reduce a likelihood that one bad score will drop the new service provider out of the top group immediately which is likely to prevent a new service provider from getting work to improve the new service provider's score.

At 712, process 700 can determine whether a new service provider's rate is within a threshold level of a lowest published rate (e.g., if a new providers rate is more than F % of the lowest rate, process 700 can determine that the new service provider's rate is not within the threshold level). For example, the threshold level can be 125%, 150%, or any other suitable level.

If process 700 determines that a new service providers rate is within the threshold level (“NO” at 712), process 700 can move to 714, and can insert that new service provider into the subset of service providers that included the top scoring service providers.

Otherwise, if process 700 determines that a new service providers rate is more than the threshold level (“YES” at 712), process 700 can exclude that new service provided from the subset of service providers and can move to 716.

At 716, process 700 can sort the subset of service providers using any suitable technique or combination of techniques. For example, process 700 can randomly order (e.g., using an unweighted or weighted random ordering) the subset of service providers, which may include new service providers. For example, process 700 can randomly select an order for the subset based on a weighting modified by the score associated with each service provider. For example, process 700 can select higher scoring service providers at a higher rate than lower scoring service providers.

In some configurations, process 700 can set a minimum position for a specific service provider that was last selected by the user, if that service provider was also rated highly (e.g., above a certain threshold of either overall score, a quality score, or specifically a star rating quality component) by the customer making the service request. In some configurations, a service provider's card can include an indicator (e.g., text, a tag, a flag) indicating that the service provider was last used, such as a “Last Used” or “Last Selected” tag.

In some configurations, process 700 can use contract data associated with the facility and/or an operator of the facility to identify preferred service providers. This data can be used to automatically determine service providers that to be added to the service providers being presented for a service request. For example, a service provider that is preferred based on contract pricing or other contractual arrangements may, or may not, be presented as a first service provider in a ranked list or may always be presented in a first group of service providers. Additionally or alternatively, in some configurations, such as preferred service provider can be presented with an indicator (e.g., text, a tag, a flag, etc.) that the service provider is a “preferred” service provider, for example, the card may be shown with a “Corporate Preference” text tag.

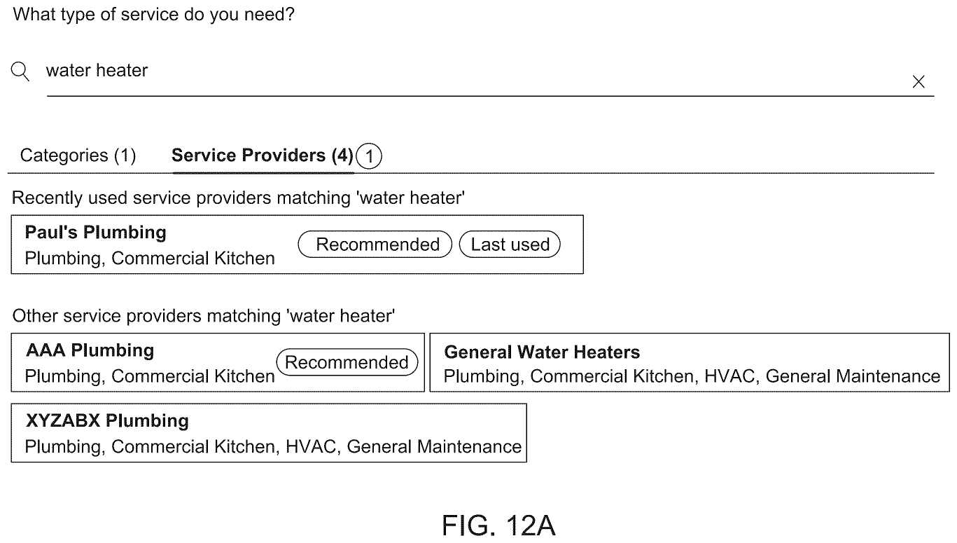

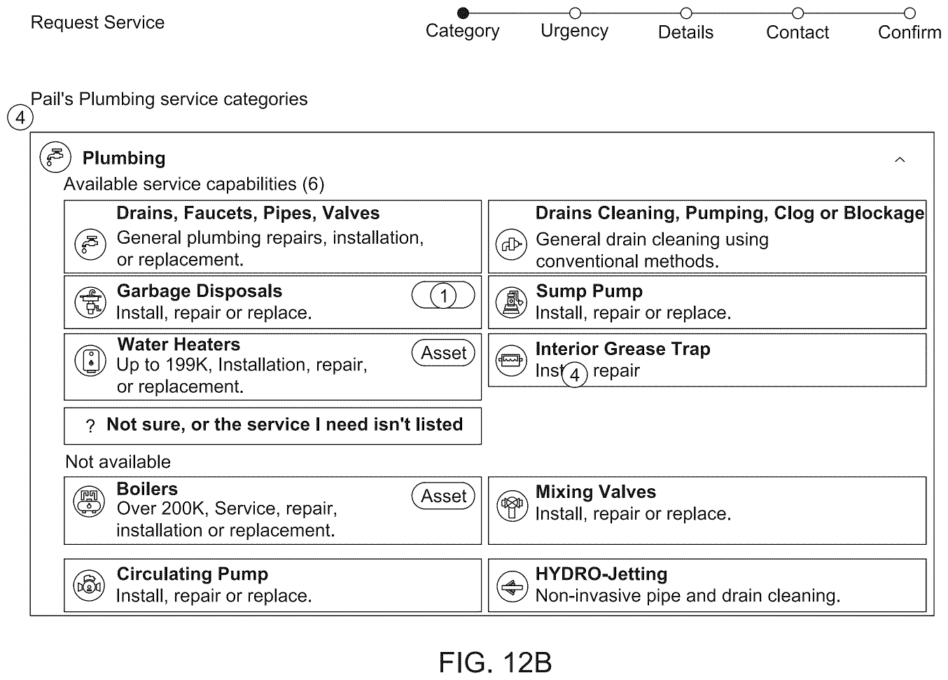

In some configurations, if a user begins by selecting a specific service provider (e.g., as described below in connection with FIGS. 12A and 12B), process 700 can still present multiple options. For example, the initially selected service provider can be included in an initial set of service providers presented to a user, and process 700 can be used to identify alternative options that the user can select.

In some configurations, process 700 can use a machine learning model(s) to identify a service provider(s) to recommend to a user based on a transaction history associated with the user, the facility, and/or an organization that manages the facility. For example, such as machine learning model can receive as input a customer's transaction history to include and recommend a service provider that has similar attribute scores that the customer prefers (e.g., as revealed by the customer's past selections).

In some configurations, such a machine learning model(s) can be used to select a top scorer on which to include a “Recommended” tag. Additionally, in some configurations, such a machine learning model(s) can use more specific data for service providers such as first-time fix rate, same day service, and urgent response time to identify a service provider to recommend based on the user's expressed preferences, revealed preferences, and/or an urgency of a current request.

In some configurations, a machine learning model can utilize other data, such as geographical and market/submarket elements, such as standard of living, labor rates, unemployment rate, and/or other suitable data. Such a machine learning model can also take into account facility data, such as criticality of equipment, experience level of maintenance staff, and proximity of the facility to service provider location. This can be used to determine the severity or urgency level of a certain request. Such a machine learning model(s) can also use facility specific data such as criticality of equipment, such as when the equipment being down is life threatening to residents. For example, residents going without food if a cooler is broken, or being exposed to unsafe temperatures if HVAC needs repair (e.g., which can be based on both equipment purpose and location, such as a hallway PTAC being less critical than a resident room PTAC). Such a machine learning model(s) can also take into account weather data for the facility location, such as extreme cold or heat at the time of the request (or more generally the season for the area), which can escalate the urgency or severity of an HVAC repair request. Such additional data can also be utilized in the weighting of attributes, in scoring, in sorting, or any suitable combination thereof. For example, high urgency requests may drastically increase the weight of speed over price.

At 718, process 700 can rank a last selected service provider (e.g., for the type of service being requested) no higher than a particular position if the last selected provider is within the subset corresponding to a top scorer group, which can include new service providers. Limiting a position of a last used service provider can reduce a likelihood that a user will consistently select the same service provider due to familiarity, even if the last used service provider may not be the best option for a current request (e.g., based on price, response time, quality, etc.).

At 720, process 700 can cause a list of service providers based on the sorted order of the subset of service providers sorted at 716 and can present service providers that were not included in the subset of service providers at 708 and/or 714 based on a performance metric (e.g., from a best performing service provider not included in the top scorer group to a worst performing service provider not included in the top scorer group).

In some configurations, process 700 can cause corresponding indicators of the predicted/anticipated score for each factor to be presented in connection with each of the service providers and/or can cause tags (e.g., “corporate preference”; “last used”; “recommended”; “high decline rate” if relevant for correlated category/urgency; etc.). In some configurations, the service providers can be presented with a user interface element that allows a user to select one of the service providers before initiating a service request.

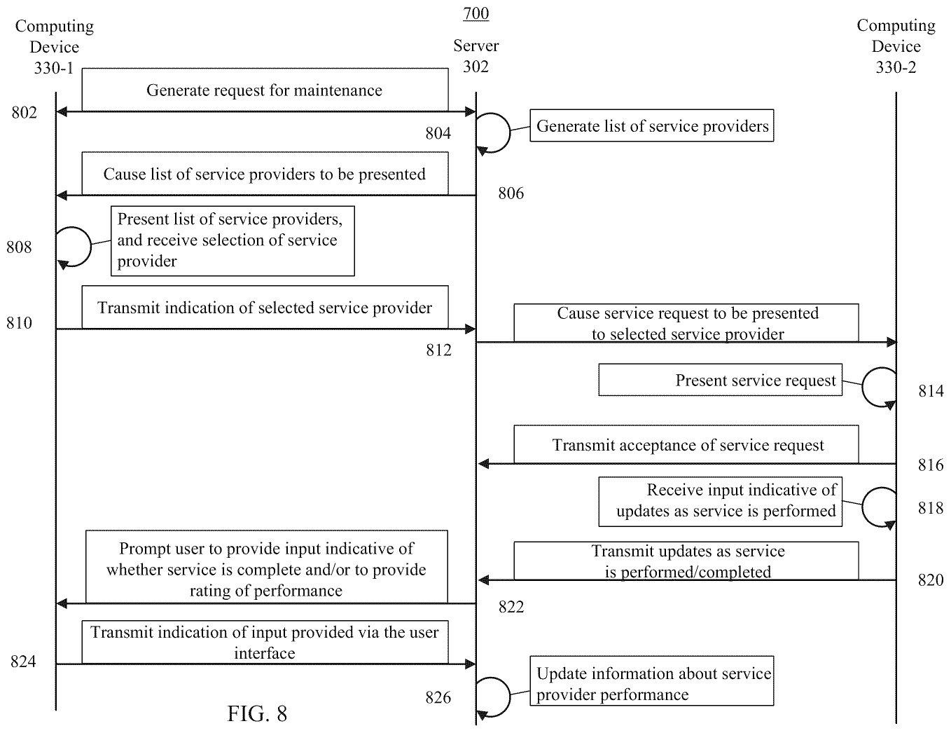

FIG. 8 shows an example of an information flow for automatically managing maintenance at a facility in accordance with some configurations of the disclosed subject matter.

At 802, a computing device 330-1 associated with a facility or organizational user (referred to herein as facility computing device 330-1) can generate a request for maintenance. In some configurations, facility computing device 330-1 can present a user interface (e.g., generated by a web application executed via a web browser, generated by a mobile or desktop application executed by facility computing device 330-1) that can be used to generate a request for maintenance.

In some configurations, facility computing device 330-1 can generate the request for maintenance in communication with server 302 (and/or any other suitable server, such as a web server, an application server, etc.). For example, in some configurations, facility computing device 330-1 can receive input via a user interface presented by facility computing device 330-1, and can provide information indicative of the input to server 302 (e.g., via JSON messages). In such an example, selection of a particular user interface can cause a request for another portion of a user interface to be requested from server 302.

Additionally or alternatively, in some configurations, facility computing device 330-1 can generate the request for maintenance via a user interface presented by an application (e.g., a web application or a desktop application) executed by facility computing device 330-1. In such configurations, facility computing device 330-1 can communicate information indicative of input received via the application executed by facility computing device 330-1 to server 302 as the request for maintenance (e.g., via an application program interface (API)), in some examples without prior communication.

In some configurations, facility computing device 330-1 can present a user interface with pointed questions and inputs based on category/scope to solicit additional details (e.g., type of work—repair, replacement, maintenance, inspection, other service; asset details such as model or age of the asset; if for a service such as tree trimming solicitation of how many trees are to be trimmed, removed, etc.) to better understand request requirements. In some configurations, facility computing device 330-1 and/or server 302 can retrieve relevant details that are available, such as asset information (model, asset location, etc.), if such information is available in asset database 204 (e.g., the user may be able to search for a particular asset and select it to auto-populate fields).

At 804. server 302 can generate a list of service providers that are capable and/or recommended to perform the maintenance requested in the request for maintenance generated at 802, using any suitable technique or combination of techniques. For example, server 302 can use techniques described above in connection with FIG. 7.

At 806, server 302 can cause a list of service providers to be presented by facility computing device 330-1 using any suitable technique or combination of techniques. For example, server 302 can transmit information that can be used to present the list (e.g., using JSON messages, using HTML messages, using an extended markup language (XML) document, etc.), which can include identifying information of the service providers, rating information, cost information, etc.

At 808, facility computing device 330-1 can present a ranked set of service providers and can receive a selection of a service provider to perform the requested service. In some configurations, facility computing device 330-1 can use any suitable technique or combination of techniques to present service providers and receive the selection of a service provider, such as techniques described below in connection with FIGS. 9I and 9J.

At 810, facility computing device 330-1 can transmit an indication of a selected service provider using any suitable technique or combination of techniques. For example, selection of a particular user interface element associated with the selected service provider (e.g., selection of the selected service provider within the user interface element) can cause facility computing device 330-1 to highlight the selected user interface element, and selection of another user interface element (e.g., a “continue” user interface element, a “select” user interface element, etc.) can cause facility computing device 330-1 to transmit an indication of which service provider is highlighted in the user interface (e.g., via an JavaScript ObjectNotation (JSON) message, a hyper-text markup language (HTML) message, etc.).

At 812, server 302 can cause a service request to be presented to the selected service provider, via a computing device 330-2 (referred to herein as service provider computing device 330-2) using any suitable technique or combination of techniques, such as techniques described above in connection with 516 of FIG. 5 (e.g., via a JavaScript Object Notation (JSON) message, a hyper-text markup language (HTML) message, etc.).

At 814, service provider computing device 330-2 can present the service request to a user associated with service provider computing device 330-2 using any suitable technique or combination of technique (e.g., presenting an email, presenting a push notification, presenting a text message, etc.). The service request could include information (e.g., name of the facility making the request, facility contact information, category and capability, type of work, location of problem in the facility, description of the issue, asset information, images of the asset and/or issue, affected areas of the facility, and the like). It may also include additional information including site instructions or facility preferences. The amount and type of information provided to the service provider computing device 330-2 can be used or otherwise associated with information such as described above, such as decline or acceptance information.

At 816, service provider computing device 330-2 can transmit an acceptance of the service request (e.g., in response to selection of a user interface associated with the service request) using any suitable technique or combination of techniques (e.g., transmitting an indication of acceptance via a JavaScript Object Notation (JSON) message, a hyper-text markup language (HTML) message, etc.).

At 818, service provider computing device 330-2 can receive input indicative of updates as service is performed (e.g., via a user interface presented via a display of service provider computing device 330-2) using any suitable technique or combination of techniques, such as techniques described above in connection with 522 of FIG. 5.

At 820, service provider computing device 330-2 can transmit updates to server 302 as service is performed and/or completed, using any suitable technique or combination of techniques (e.g., transmitting indications of updates via JSON messages, HTML messages, etc.).

At 822, server 302 can prompt a user to provide input indicative of whether the service provider has arrived to perform service, has completed service, and/or to provide a rating of performance (e.g., via a user interface presented by facility computing device 330-1).

At 824, facility computing device 330-1 can transmit an indication of input provided via the user interface, such as a confirmation that the service provider has arrived to perform service, has completed service, etc., using any suitable technique or combination of techniques (e.g., transmitting indications of input provided via JSON messages, HTML messages, etc.).

At 826, server 302 can update information about service provider performance based on updates received from service provider computing device 330-2 and/or facility computing device 330-1 (e.g., as described above in connection with 524 of FIG. 5).

FIG. 9A shows an example 900 of a user interface for automatically managing maintenance at a facility in accordance with some configurations of the disclosed subject matter.

As shown in FIG. 9A, a user interface can include a selectable user interface element 902 that can be selected to initiate a new service request, a user interface portion 904 which can be used to present previously submitted service requests and/or service requests that are in progress (e.g., a service request that has been initiated but not yet completed), and a search user interface portion 906 which can be used to search for performed services and/or initiate a search for providers.

In some configurations, selection of user interface element 902 can cause the user interface to present a user interface for initiating a service request (e.g., as described below in connection with FIG. 9B).

FIG. 9B shows an example 910 of a user interface for initiating a service request in accordance with some configurations of the disclosed subject matter.

As shown in FIG. 9B, a user interface can include a user interface portion 912 that can include selectable user interface elements corresponding to various categories of service providers (e.g., commercial kitchen, electrical, fire protection, etc.), and a search user interface portion 914 which can be used to search for particular service providers and/or categories.

In some configurations, selection of a user interface element within user interface portion 912 can cause the user interface to present service capabilities within the selected category (e.g., as described below in connection with FIG. 9C).

In some configurations, entering one or more search terms in search user interface portion 914 (which can include autocomplete functionality) can cause search results to be presented (e.g., as described below in connection with FIGS. 12A and 12B).

In some configurations, user interface portion 912 and/or search user interface portion 914 can present multiple options to the user to search or expand categories or service providers: search via asset type (e.g., ice machine, boiler); search via category (e.g., HVAC, Plumbing, Electrical); click on categories to expand available and unavailable capabilities within category; search by service provider name and view results; and search available service providers within a category or capability. If a user clicks on a category (e.g., plumbing), user interface 920 can display results when expanding category or searching. The user may then click on an available capability (e.g., “General plumbing repairs & installation”), as described below in connection with FIG. 9C.

FIG. 9C shows an example 920 of a user interface for selecting a particular initiating a service request in accordance with some configurations of the disclosed subject matter.

As shown in FIG. 9C, user interface 920 can include a user interface portion 922 that can include selectable user interface elements corresponding to various service capabilities of contractors that can perform the selected category of service (e.g., plumbing), and an internal notes interface portion 924 which can be used to add notes to the service request being generated. In some configurations, the internal notes interface portion 924 can be conditionally available based on user access (e.g., it can be available to administrative users, and may not be available to other users).

In some configurations, selection of a user interface element within user interface portion 922 can cause the user interface to progress to a next user interface (e.g., to specify assets to be repaired, replaced, etc., to specify an urgency of the request, etc.).

In some configurations, entering one or more search terms in search user interface portion 914 (which can include autocomplete functionality) can cause search results to be presented (e.g., as described below in connection with FIGS. 12A and 12B).

FIG. 9D shows an example 930 of a user interface for indicating an urgency associated with a service request in accordance with some configurations of the disclosed subject matter.

As shown in FIG. 9D, user interface 930 can include a user interface portion 932 that can include selectable user interface elements (e.g., radio buttons) to specify an urgency of the request (e.g., standard, urgent, critical, etc.), and a continue user interface element 934 which can be used to transition to a next portion of the user interface when an urgency is selected (selection of user interface element 934 can be inhibited unless an urgency is selected).

In some configurations, selection of a critical emergency can cause a user interface to be presented to prompt a user to explain a nature of the critical emergency.

FIG. 9E shows an example 940 of a user interface for specifying a nature of an emergency that led to selection of a critical emergency user interface element in accordance with some configurations of the disclosed subject matter.

As shown in FIG. 9E, user interface 940 can include a user interface portion 932 that can include selectable user interface elements (e.g., check boxes) to specify a nature of an emergency situation (e.g., a life safety emergency, a large dollar loss, a potential evacuation), and a continue user interface element 944 which can be used to transition to a next portion of the user interface when the user specifies a nature of an emergency situation (selection of user interface element 944 can be inhibited unless at least one check box in user interface portion 942 is selected). For example, if a customer selects critical emergency, user interface 940 can be presented to prompt the user to clarify a nature of the emergency situation. Additionally, the user can be prompted to select a less urgent category if the user would like to wait for a particular service provider, such that the user can wait for a specific service provider.

FIG. 9F shows an example of a user interface for indicating whether repair or replacement is required for the service request in accordance with some configurations of the disclosed subject matter.

As shown in FIG. 9F, user interface 950 can include a user interface portion 952 that can include selectable user interface elements (e.g., radio buttons) to specify a nature of work to be performed (e.g., repair, installation or replacement, installation, replacement, etc.), and a continue user interface element 954 which can be used to transition to a next portion of the user interface when the user specifies a nature of the work to be done (selection of user interface element 954 can be inhibited unless at least a radio buttons within user interface portion 942 is selected).

In some configurations, selection of a particular user interface element within user interface portion 952 can cause the user interface to progress to an appropriate next user interface (e.g., an appropriate specific question set, as repair questions and answers can vary from replacement/new installation questions and answers).

FIG. 9G shows an example of a user interface for specifying details of an asset associated with the service request in accordance with some configurations of the disclosed subject matter.

As shown in FIG. 9G, user interface 960 can include a user interface portion 962 that can include prompts to help a user specify details about the service to be performed (e.g., including check boxes), a user interface portion 964 to search for an asset (e.g., in a public database, in a portion of asset database 204 associated with the facility), a user interface portion 966 that can be used to provide (e.g., upload) images of the asset(s) associated with the service request, a location of the asset, etc., a user interface portion 968 to provide any additional details for the service provider. specify a nature of work to be performed (e.g., repair, installation or replacement, installation, replacement, etc.), and a continue user interface element 969 which can be used to transition to a next portion of the user interface when the user provides details about the work to be performed (selection of user interface element 969 can be inhibited unless particular fields, boxes, and/or buttons have been selected and/or filled).

In some configurations, user interface 960 can present detailed questions regarding the work needed. Such questions can depend on the category/capability and type of work requested. These questions can also solicit information that can be used to determine which service provider to recommend (e.g., as some service providers perform better with certain types of work).

In some configurations, the user can be required to indicate details of an asset for specific capabilities but can be presented with an option to indicate that the user is not near the asset in order to retrieve pertinent details (e.g., make, model, and serial number). In some configurations, such information can be auto populated using asset information from stored information in asset database 204. For example, a user can search for the asset in asset database 204 using any suitable technique or combination of techniques. In a more particular example, the user can search based on the location and/or type of asset (e.g., via text, via a list, via a map of the facility, etc.). As another more particular example, the user can search based on identifying information (e.g., a serial number, another identification number, etc.) of the asset, which can be provided manually by the user, or using a device to automatically retrieve/provide the identifying information (e.g., via a camera scanning a serial number and/or other identifying information, via a camera scanning a computer-readable code such as a QR code or barcode, via a device scanning an RFID tag, etc.). In some configurations, asset information can be used to select a category and/or capability to be associated with a request for maintenance (e.g., in lieu of a user selecting a category and/or capability as described above in connection with FIGS. 9B and 9C).

FIG. 9H shows an example of a user interface 970 for specifying contact information to be associated with the service request in accordance with some configurations of the disclosed subject matter.

As shown in FIG. 9H, user interface 970 can include a user interface portion 972 that can include prompts to select a contact and/or add contact information for a main point of contact for the service request (e.g., by selecting from a drop down of stored contacts, by adding text to fields, etc.), a user interface portion 974 that can be used to specify entry and access instructions and/or requirements for the service provider (e.g., where to enter, a code to user to enter, whether to wear a mask, etc.), and a continue user interface element 976 which can be used to transition to a next portion of the user interface when the user provides contact details and/or site instructions (selection of user interface element 976 can be inhibited unless particular fields, boxes, and/or buttons have been selected and/or filled).

In some configurations, multiple contacts can be added as a contact for the service request (e.g., by selecting a user interface element 978, which can add additional contact fields within user interface portion 972).

FIG. 9I shows an example of a user interface 980 for indicating a selection of a preferred service provider from a subset of recommended service providers in accordance with some configurations of the disclosed subject matter.

As shown in FIG. 9I, user interface 980 can include a user interface element 982 (e.g., formatted as a dropdown) that can be used to specify an order in which results are presented (e.g., in a recommend order, by performance metric, alphabetically, etc.), a search user interface portion 984 which can be used to search for particular service providers within the results, a user interface portion 986 which can be used to present ranked lists, a no preference user interface element 987 which can be selected to allow a system to select the service provider or select a next service provider (e.g., selecting a highlighted service provider, selecting a recommended service provider if no service provider is highlighted, etc., and if an initially selected service provider declines, selecting a next service provider), and a continue user interface element 988 which can be used to transition to a next portion of the user interface when the user selects a service provider or selects no preference user interface element 987 (selection of user interface element 988 can be inhibited unless particular fields, boxes, and/or buttons have been selected and/or filled).

In some configurations, for a request (e.g., a P1 urgency request, or any other suitable urgency request), the customer can select a preferred option, and can also select “No Preference” user interface element 987. In some configurations, user interface 980 can include messaging indicating that the system will first attempt to send a preferred service provider and can change a service provider due to time being the most critical factor to the user (e.g., if the preferred service provider is unavailable).

In some configurations, a “tag” user interface element can be presented to provide additional information about a service provider. For example, a “recommended” tag can indicate that a particular service provider is recommended. As another example, a “last used” tag can indicate that a particular service provider was selected a last time that a service provider was used to perform similar maintenance at the facility (e.g., based on a category and/or service capability associated with the request and the most recent request). As yet another example, a “corporate preferred,” “corporate recommended,” or similar tag can indicate that a particular service provider has been identified by a corporate user (e.g., associated with an operator, such as operator 222 or 224) as a service provider that is preferred (e.g., due to a contractual relationship).

In some configurations, a “rating” user interface element can be presented to provide information about customer ratings of the service provider (e.g., as described above in connection with 522 of FIG. 5).

In some configurations, a “response” user interface element can be presented to provide information about a service provider's historical and/or predicted response time.

In some configurations, a “rate” user interface element can be presented to provide information about a rate charged by the service provider.

FIG. 9J shows an example of a user interface 990 for verifying details associated with a service request in accordance with some configurations of the disclosed subject matter.

As shown in FIG. 9J, user interface 990 can include details of the request, and a continue user interface element 992 which can be used to initiate purchase of the requested service.

FIG. 9K shows an example of a user interface 994 for confirming that service has been requested from a service provider in accordance with some configurations of the disclosed subject matter.

As shown in FIG. 9K, user interface 994 can confirm that the service has been requested, and that the user can expect to receive additional information.

FIG. 10 shows an example diagram of a process for automatically identifying and recommending appropriate service providers to respond to a request for maintenance associated with an asset at a facility in accordance with some configurations of the disclosed subject matter.

In FIG. 10, a particular example of generating a ranked list of recommended providers is shown, which different portions shown labeled with a portion of FIG. 7 represented by in the visual example shown in FIG. 10.

FIG. 11 shows an example diagram of scoring for a service provider that has insufficient data for at least one category in accordance with some configurations of the disclosed subject matter. As shown in FIG. 11, when a particular metric does not include sufficient data, a score for the service provider (SP) can be adjusted by excluding the possible points from that particular metric.

FIG. 12A shows another example of a user interface for initiating a service request in accordance with some configurations of the disclosed subject matter.

As shown in FIG. 12A, when a user uses a search user interface (e.g., search user interface 906) to initiate a service request, a user interface can present service providers that are capable of providing a service based on the search term(s) entered in the search user interface.

For example, in some configurations, searching by capability (e.g., water heater) can present resulting categories and/or service providers. In some configurations, the view can split service providers into recently used service providers and others, and can include flags for “Recommended”, “Last used”, etc., which may be based on a scoring process (e.g., as described in connection with FIG. 7).

FIG. 12B shows another example of a user interface for selecting a particular capability of a particular service provider initiating a service request in accordance with some configurations of the disclosed subject matter.

In FIG. 12B, an expanded view of a specific service provider displaying the service provider's capabilities are shown when searching via service provider name or capabilities. In some configurations, an asset flag can be included for a capability based on whether the customer facility is associated with an asset corresponding to the capabilities (e.g., based on asset database 204). In some configurations, the expanded view in FIG. 12B can show a service provider's available capabilities, which are selectable, and unavailable capabilities, which are not selectable. Additionally, in some configurations, if a user begins by selecting a specific service provider, a process of identifying and recommending service providers can be similar, and multiple options can be presented (e.g., as shown in FIG. 9I). In some such configurations, a service provider that was initially selected can be automatically included in the top service providers that are presented (e.g., regardless of whether the service provider's performance would merit inclusion otherwise) and/or can be highlighted (e.g., initially selected) (e.g., as shown in FIG. 9I in the example of Paul's Plumbing), and alternative options can also be presented (e.g., representing top performing service providers and/or a new service provider(s)) for potential selection by a user.

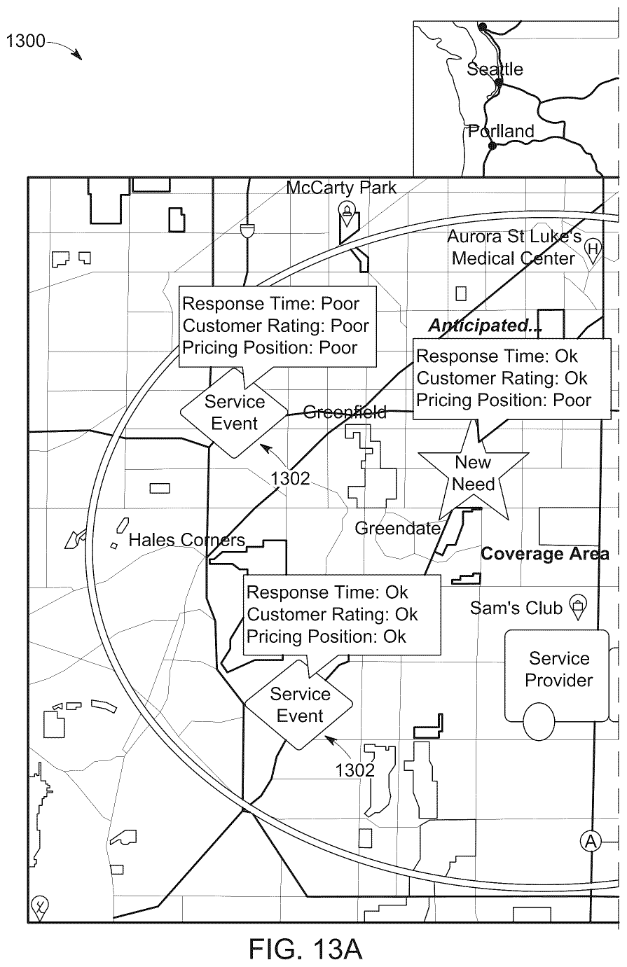

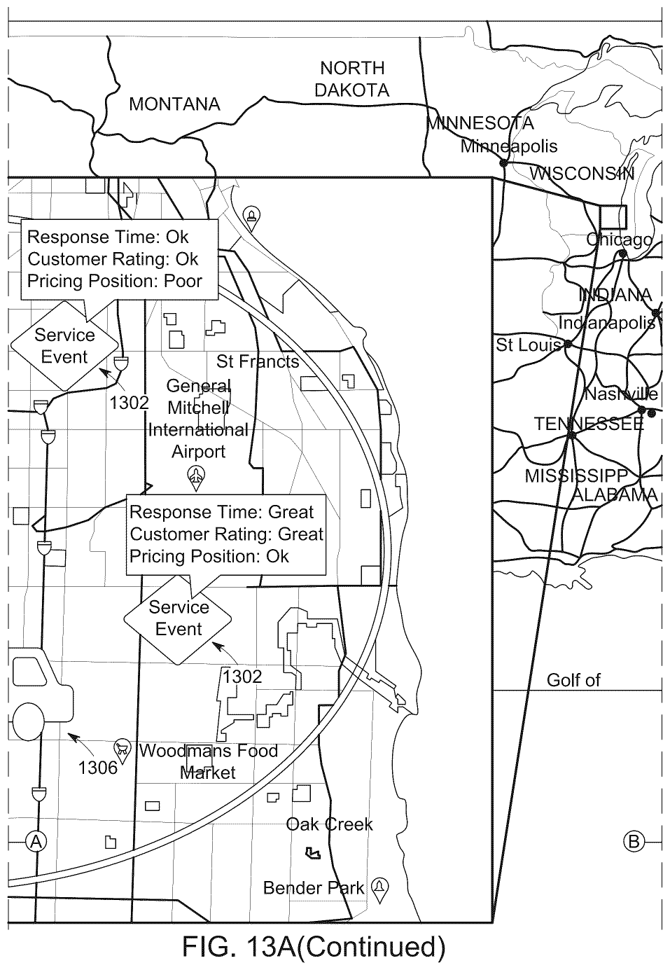

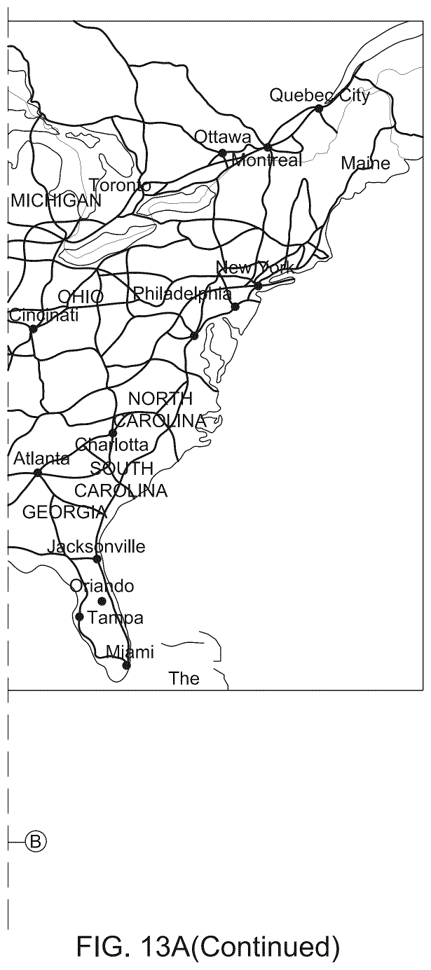

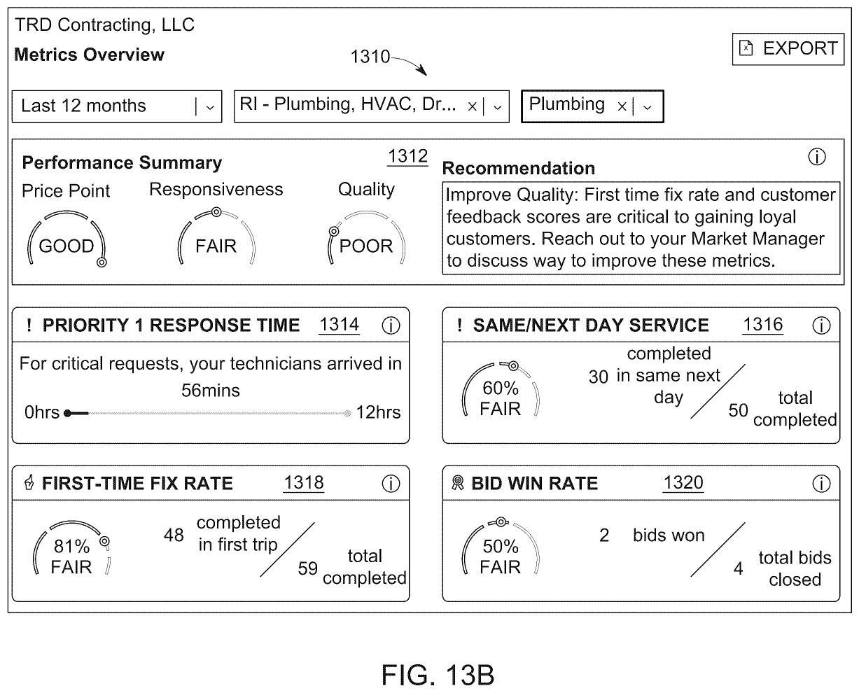

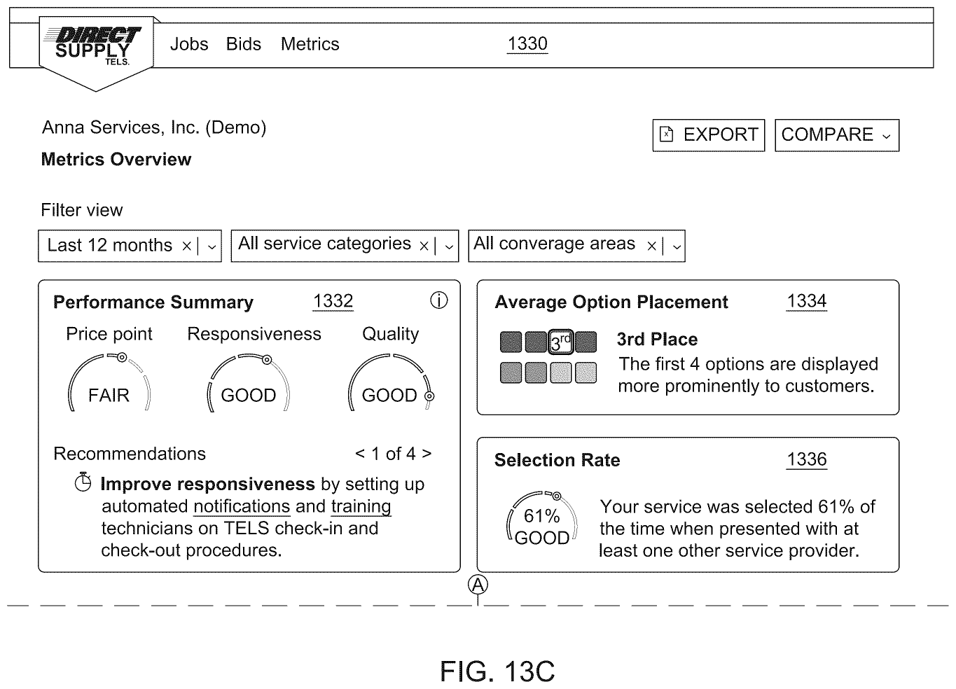

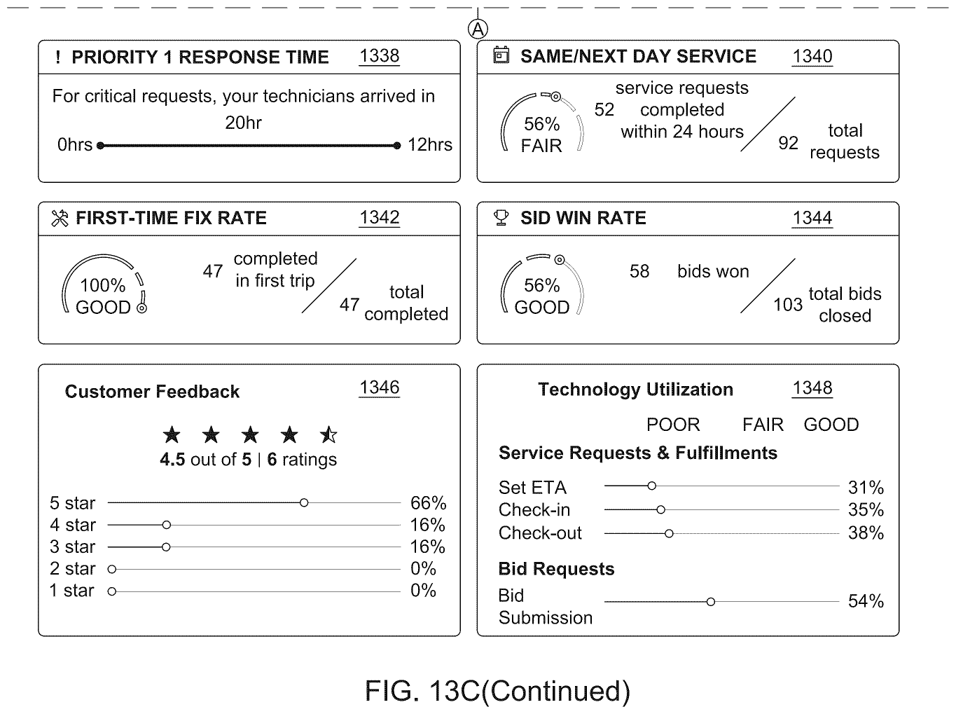

FIG. 13A shows an example 1300 of a user interface for a service provider showing service event scores for the service provider and anticipated scores for a new service request in accordance with some configurations of the disclosed subject matter.

As shown in FIG. 13A, in some configurations, user interface 1300 for a service provider can show relatively recent service events 1302 that the service provider completed, which can be presented with information indicative of an overall performance (e.g., indicated by color, with red, yellow, green corresponding to poor, fair, and good performance, respectively), and particular performance in one or more categories (e.g., indicated by text as poor, fair, and good performance). The locations of the service events that were performed can be presented on a map 1304 with respect to a location 1306 of the service provider. The combination of the location presentation and the performance information can potentially be indicative of a relationship between location and performance (e.g., a service provider may have longer response times for service events that are farther from the service provider). Additionally, in some configurations, one or more anticipated service events can be presented in the user interface with an anticipated score for the service provider for the anticipated service event. This can help the service provider determine how the service provider is positioned to win a bid for an anticipated service event.

FIG. 13B shows an example 1310 of a user interface for a service provider showing performance of the service provider on the various metrics in accordance with some configurations of the disclosed subject matter. FIG. 13C shows another example 1330 of a user interface for a service provider showing performance of the service provider on the various metrics in accordance with some configurations of the disclosed subject matter.

As shown in FIGS. 13B and 13C, in some configurations, a service provider can view a user-interface with a metrics overview, which can show service providers to see how the service provider performance impacts their opportunities. In some configurations, the user interface can include modular cards that display different information.

In some configurations, the user interface can include a card 1312 or 1332 with a “Performance Summary” based on an analysis of the service provider relative to other service providers in the local market or globally. The performance summary can include Price Point, Responsiveness, and Quality. It can show a visual indicator and text (e.g., “Poor”, “Fair”, “Good”, “Great”) indicating performance for each metric. It can also include recommendations for how to improve these metrics. For example, a message can be based on the lowest performing metric (e.g., “Your response time seems to be X % slower than other similar service providers in your market, to improve your chance at getting work, you may want to . . . ”). The message can include links to outside materials. For example, materials for how to set up automated notifications or technician training materials for check-in and check-out procedures (e.g., to train the technician so that the technician does not fail to check-in causing the response time to be later than it actually is). This can also help improve the data that is collected for a machine learning model and/or scoring techniques (e.g., as described above in connection with FIG. 7).

In some configurations, the user interface can include a card 1334 for “Average Option Placement” showing the average position of the service provider when included in the results list for a service request. For example, the card can indicate the service provider is on average in “1st”, “2nd”, “3rd”, “4th” place, etc.

In some configurations, the user interface can include a card 1336 for “Selection Rate” that shows the percentage of time that the service provider was selected when presented with at least one other service provider. It can show text with a percentage for the Selection Rate. This can be based on the relative performance compared to other service providers in the local market or globally. It may also include text (e.g., “Poor”, “Fair”, “Good”, “Great”, etc.) that indicates performance.

In some configurations, the user interface can include a card 1314 or 1338 for “Priority-1 Response Time” showing the average technician response time for critical emergency (i.e., P1) service requests. It can include a visual indication or message indicating how the service provider is performing. This can be based on performance compared to set response time standards or performance relative to other service providers in the local market or globally. The visual indicator can include the value with the average response time, and a bar indicating how the average response time falls within a desired response time scale (e.g., 0 to 12 hour response time). It can also include text (e.g., “Poor”, “Fair”, “Good”, “Great”) that indicates performance.

In some configurations, the user interface can include a card 1316 or 1340 for “Same Day Service” including the percentage of service requests completed within 24 hours from the time the service request was accepted (e.g., a P2 request). The card can also include the total number of requests, and the number of requests completed within 24 hours. It can also include a visual indicator and text (e.g., “Fair”, “Good”, “Great”) that indicates performance.

In some configurations, the user interface can include a card 1318 or 1342 for “First-Time Fix Rate” including the percentage of service requests completed during the first visit. The card can also include the total number of requests completed, and the number of requests completed during the first trip. It can also include a visual indicator and text (e.g., “Poor”, “Fair”, “Good”, “Great”) that indicates performance.

In some configurations, the user interface can include a card 1320 or 1344 for “Bid Win Rate” including the percentage of bids won by the service provider. The card can also include the total number of bids closed, and the number of bids won. It can also include a visual indicator and text (e.g., “Poor”, “Fair”, “Good”, “Great”) that indicates performance.

In some configurations, the user interface can include a card 1346 for “Customer Feedback” including the average customer rating. It can include text for the rating out of 5-stars, and a visual indicator (e.g., multiple images of stars corresponding to the rating). It can include the number of customer ratings. It can also include the percentage of ratings that are 5-star, 4-star, 3-star, 2-star, 1-star along with visual indicators such as sliders. The user interface can include an option for allowing the service provider to communicate with a customer that left a poor rating in order to remedy the situation and provide an opportunity for the customer to update their rating accordingly.

In some configurations, the user interface can include a card 1348 for “Technology Utilization” showing the percentage Service Requests & Fulfillments where the technician utilized technology (e.g., for “Set ETA”, “Check-in”, and “Check-out”). It can also include a percentage for Bid Requests where the technology was utilized for “Bid Submissions”.

In some configurations, the visual indicator and/or text indicating performance for each card can be based on performance compared to configured standards or can be relative performance compared to a local market or global. Each of the cards can also have a header with a color indicating the performance of that corresponding metric (e.g., red, yellow, green corresponding to poor, fair, and good performance, respectively). The visual indicators on the card indicating the performance can similarly change color to indicate performance. This can help to show how competitive the service provider is in a given market.

In some configurations, the user interface can also include the ability to sort the metrics overview by timeframe (e.g., within the last 12 months), by service category or set of categories (e.g., all service categories), and by coverage areas (e.g., all coverage areas). In some configurations, it can also include the ability to export the metrics overview (e.g., PDF, Excel spreadsheet, etc.). It can also include an option for comparing the metric performance to the local market or globally. This can be an indicator for where the global and/or market top performing service providers (e.g., top 20% within a region) are performing.

In some configurations, the user interface can include an indicator of customer preference either average or a specific customer or group of customers. This can be simply exposing the service provider to what customers tend to value the most amongst speed, quality, price, etc. This along with the current performance of the service provider can help the service provider know what to focus on improving.

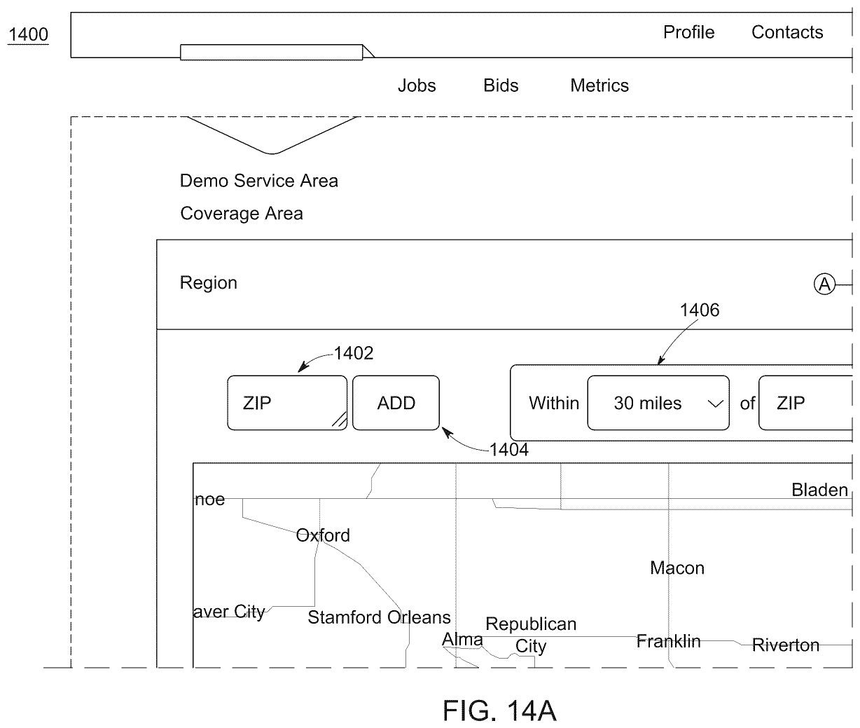

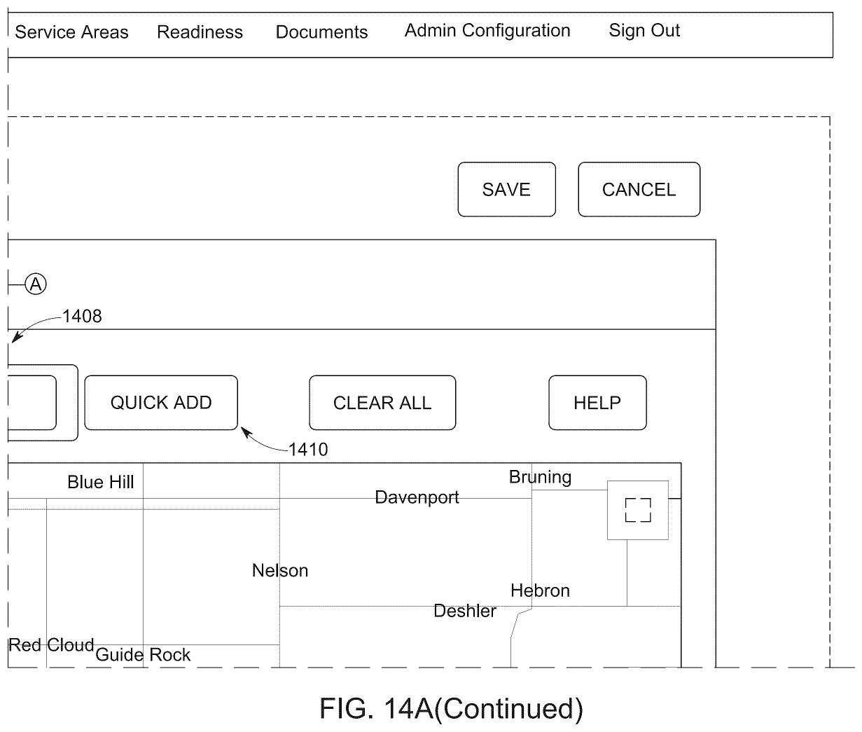

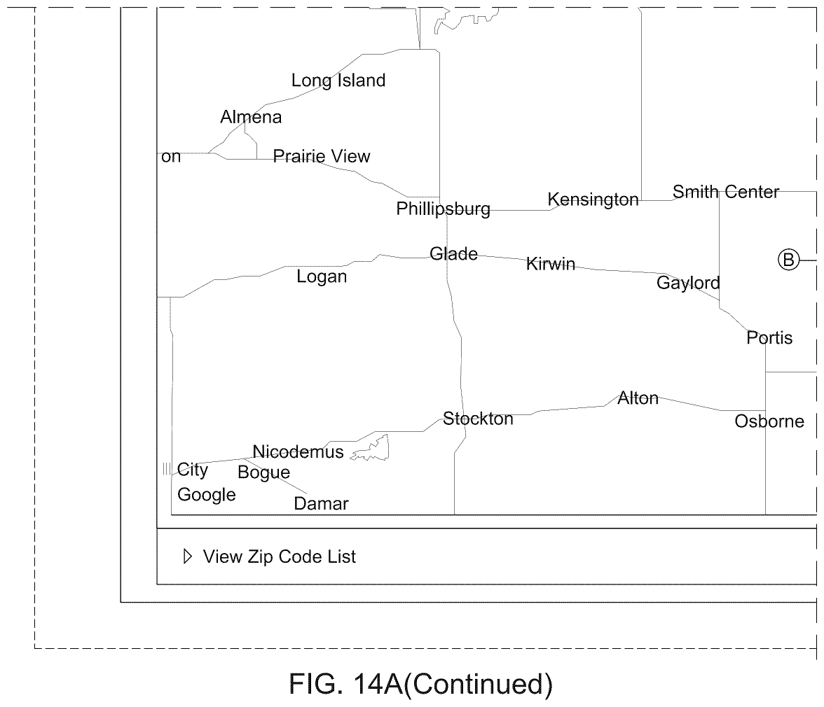

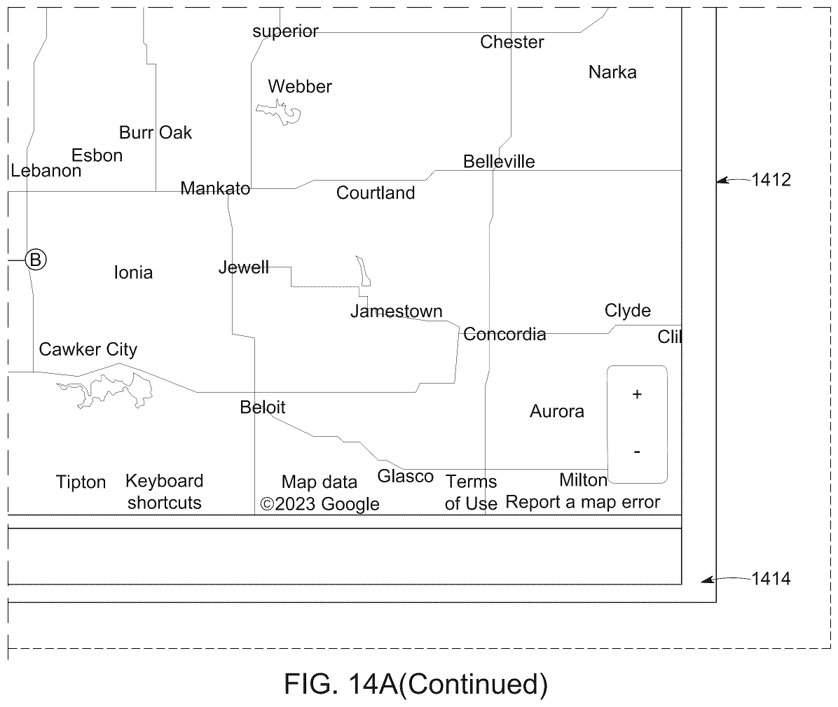

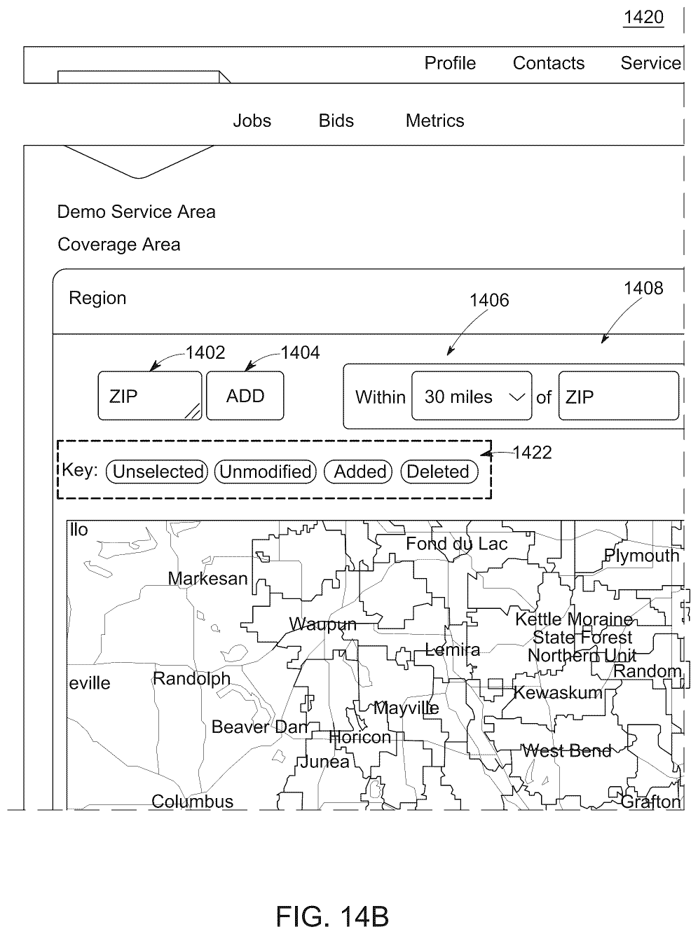

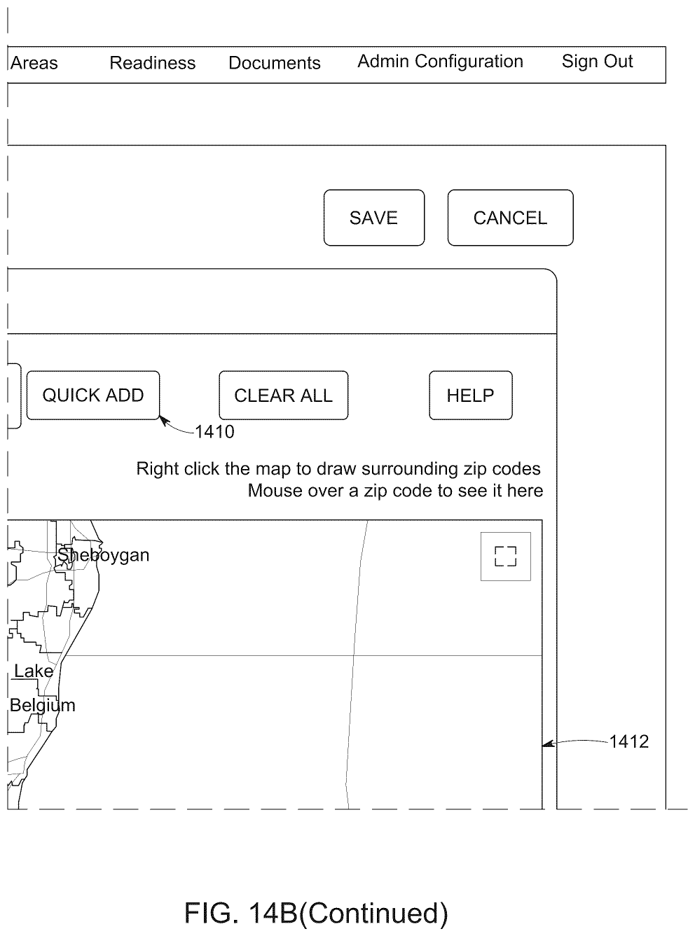

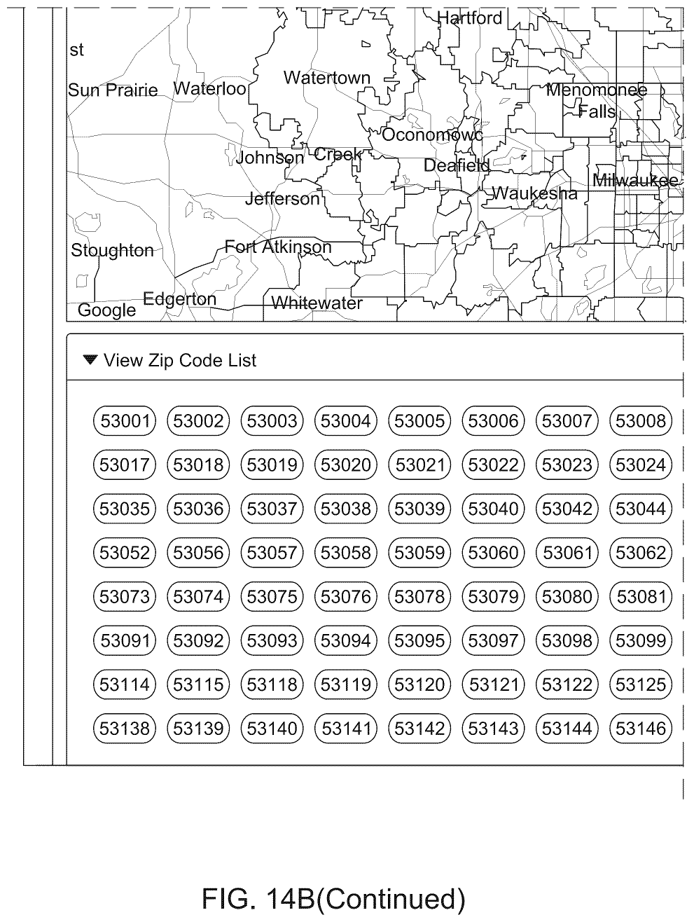

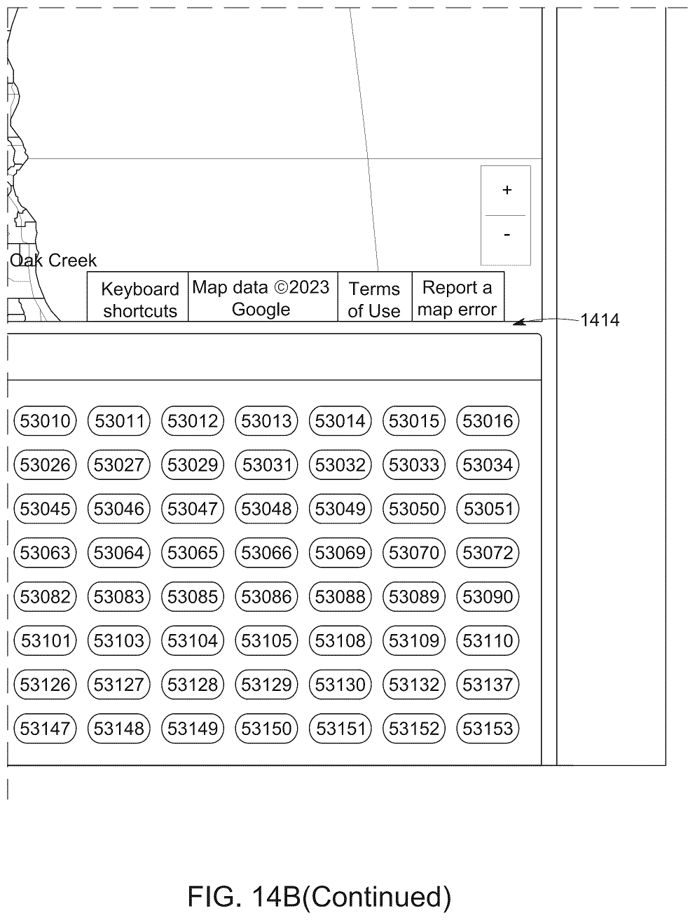

FIG. 14A shows an example 1400 of a user interface for a service provider to define a service area for the service provider in accordance with some configurations of the disclosed subject matter.

As shown in FIG. 14A, user interface 1400 can include an area user interface field 1402 (e.g., a ZIP code entry field) that can be used (e.g., by a user associated with a service provider) to input an area to be added to a service area, and a selectable user interface element 1404 that can be used to add an area in user interface field 1402 to the service area. Additionally or alternatively, in some configurations, user interface 1400 can include a dropdown user interface element 1406 which can be used to select a distance (e.g., in miles, in kilometers, etc.), an area user interface field 1408 (e.g., a ZIP code entry field) that can be used (e.g., by a user associated with a service provider) to input a reference area to be used to add a larger area (e.g., associated with a group of ZIP codes), and a selectable user interface element 1410 that can be used to add the larger area specified by dropdown user interface element 1406 and area user interface field 1408.

In some configurations, user interface 1400 can include a map area 1412 that can be used to present an area(s) that have been included in the service provider's service area, and a selectable user interface element 1414 that can be used to present a text-based list of areas that are included in the service area.

FIG. 14B shows another example 1420 of a user interface for a service provider to define a service area for the service provider in accordance with some configurations of the disclosed subject matter.

As shown in FIG. 14B, user interface 1420 can include a key 1422 that associate particular colors with areas of the maps. For example, unselected areas can be associated with the color grey, areas that have been added to the service area (e.g., in the current session using user interface 1420) can be associated with the color green, unmodified areas that are included in the service area can be associated with the color blue (e.g., areas that have been previously added, via user interface 1420), and areas that have been deleted from the service area can be associated with the color red (e.g., areas that have been deleted via user interface 1420, or areas that have been deleted automatically based on decline rates).

In some configurations, map area 1412 can be a graphical user interface that can be used to add and/or delete areas to the service area (e.g., by drawing an area, by selecting a particular area, etc.).

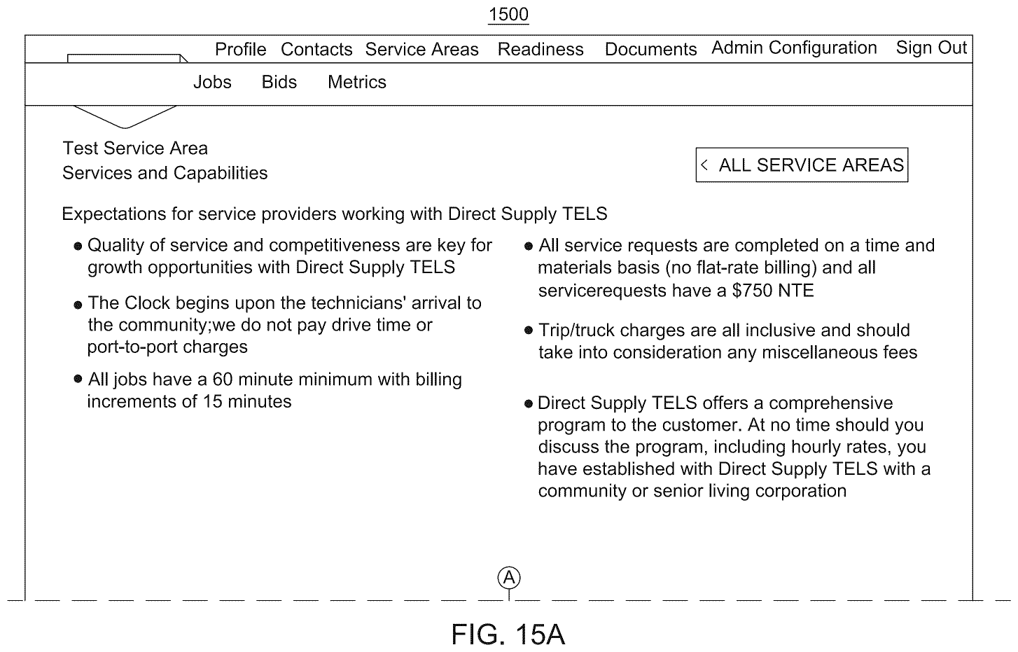

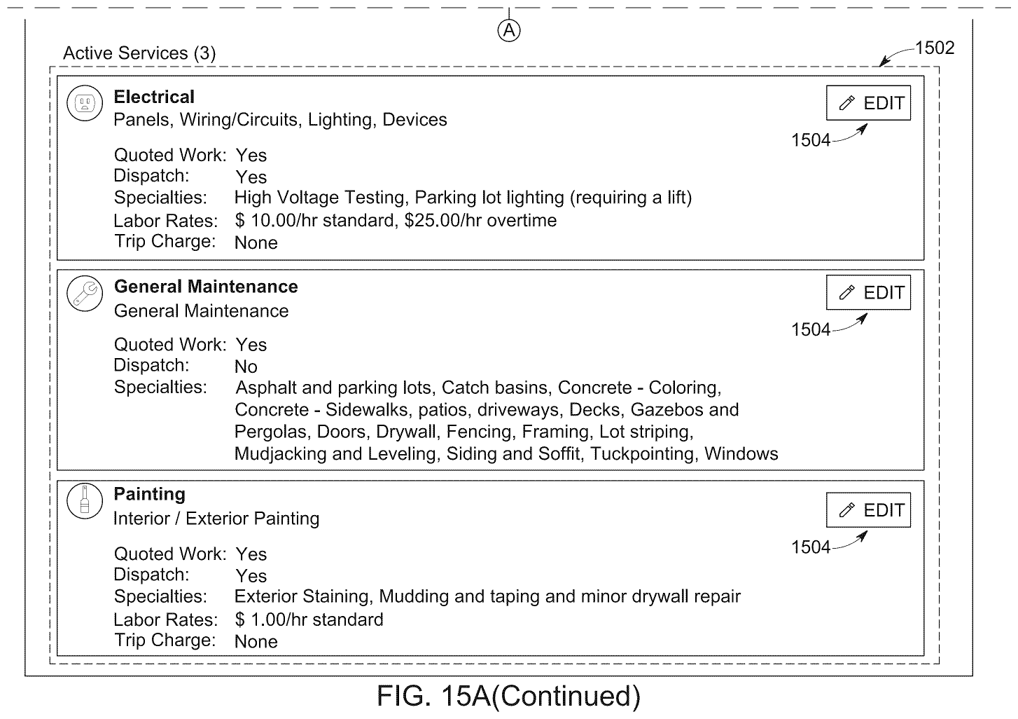

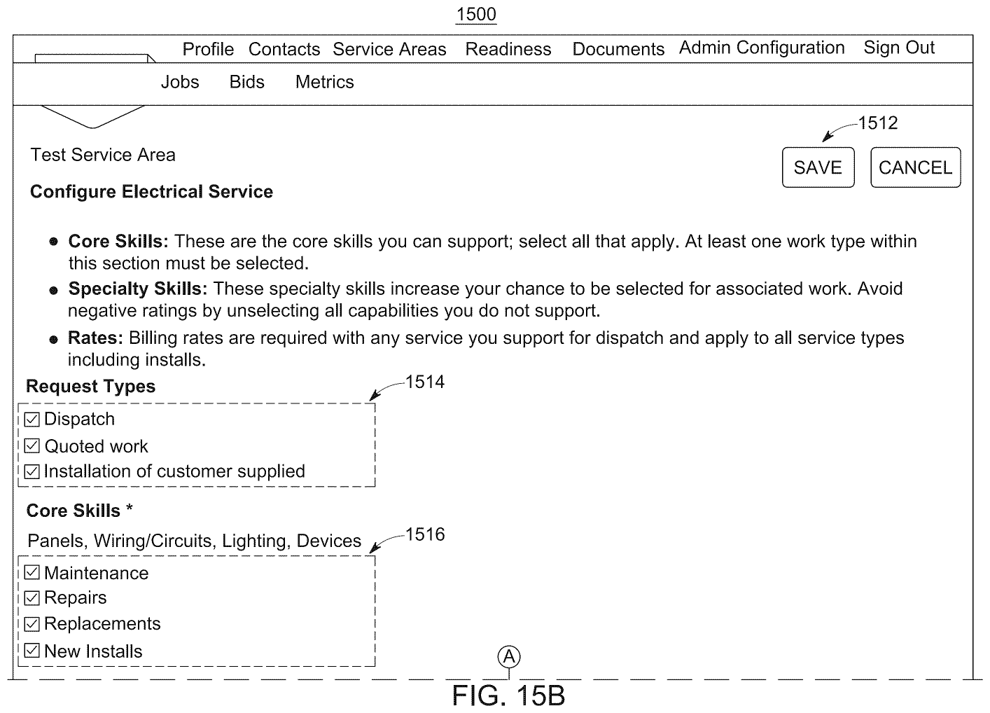

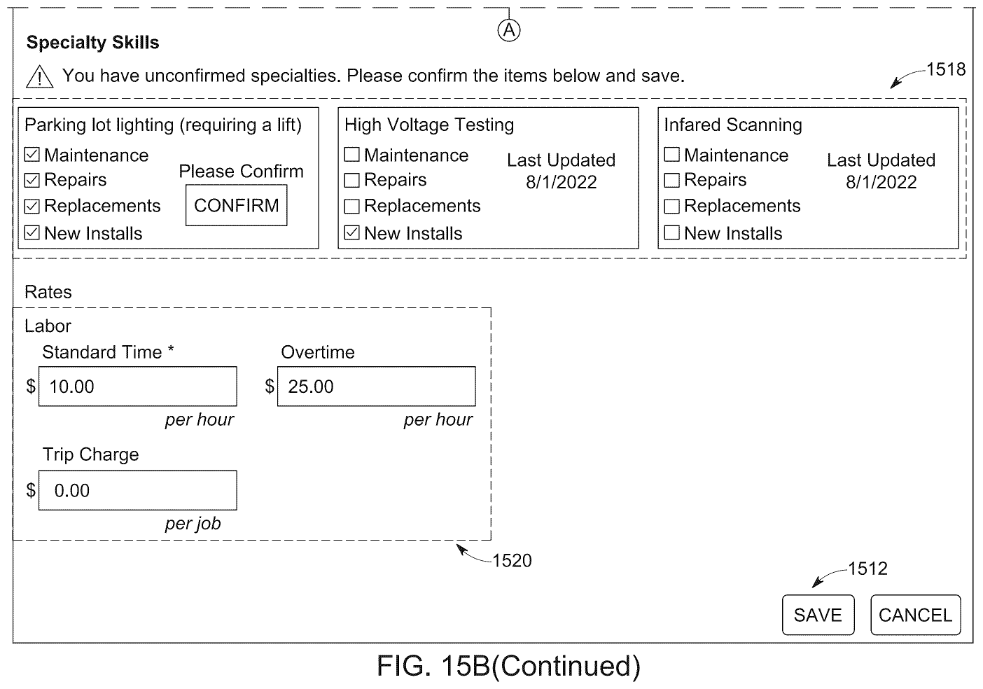

FIG. 15A shows an example 1500 of a user interface for a service provider to define and/or modify services and/or capabilities that the service provider offers in accordance with some configurations of the disclosed subject matter.

As shown in FIG. 15A, user interface 1500 can include a list 1502 of services that a service provider is offering. In some configurations, properties associated with each type of service can be summarized and can be associated with a selectable edit user interface element 1504 that can be used to edit properties associated with that type of service. In some configurations, the types of services associated with the service provider can be populated based on information provided by the service provider and/or verified by an administrator of a maintenance management system associated with user interface 1500 (e.g., maintenance management system 202).

FIG. 15B shows another example 1510 of a user interface for a service provider to define and/or modify services and/or capabilities that the service provider offers in accordance with some configurations of the disclosed subject matter.

As shown in FIG. 15B, user interface 1510 can include a selectable save user interface element 1512 that can be used to save current properties associated with the service. In some configurations, user interface 1510 can include a user interface area 1514 that can include selectable user interface elements (e.g., check boxes) that can be selected or unselected to indicate whether the service provider is willing to accept certain types of maintenance requests. In some configurations, user interface 1510 can include a user interface area 1516 that can include selectable user interface elements (e.g., check boxes) that can be selected or unselected to indicate whether the service provider provides services associated with certain core skills associated with the service type being edited. In some configurations, user interface 1510 can include a user interface area 1518 that can include selectable user interface elements (e.g., check boxes) that can be selected or unselected to indicate whether the service provider provides services associated with certain specialty skills associated with the service type being edited. In some configurations, user interface 1510 can include a user interface area 1520 that can include user interface elements (e.g., text fields, drop downs, etc.) that can be used to specify certain rates charged by the service provider.

### Further Examples Having a Variety of Features:

Implementation examples can include a method for maintaining components of a facility using a customized user interface. The method can include causing a user interface to be presented and receiving, via the user interface, a request for service to a particular asset at a particular facility, wherein the particular facility is associated with a geographic location, and wherein the particular asset is associated with an asset type. The method can also include receiving a ranked list of service providers, wherein a ranking of the ranked list is based on a performance metric associated with each of the plurality of service providers and presenting, via the user interface, at least a portion of the ranked list. Furthermore, the method can include receiving, via the user interface, a selection of a particular service provider and transmitting, to a server, a request to perform the requested service.

Another example can include a method for coordinating maintaining components of a facility across a plurality of facilities. The method can include receiving, at a server, a request from a user device for service to be performed for a particular asset at a particular facility, wherein the particular facility is associated with a geographic location, and wherein the particular asset is associated with an asset type. The method can also include compiling a ranked list of service providers, wherein a ranking of the ranked list is based on a performance metric associated with each of the plurality of service providers and sending, to the user device, at least a portion of the ranked list. Furthermore, the method can include receiving, at the server, a request to have a selected particular service provider perform the requested service at the particular facility and communicating the request to perform the requested service at the particular facility to the selected particular service provider.

It should be noted that, as used herein, the term mechanism can encompass hardware, software, firmware, or any suitable combination thereof.

It should be understood that the above described steps of the processes of FIGS. 5-7 can be executed or performed in any order or sequence not limited to the order and sequence shown and described in the figures. Also, some of the above steps of the processes of FIGS. 5-7 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

As used herein in the context of computer implementation, unless otherwise specified or limited, the terms “component,” “system,” “module,” “controller,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, the phrase “at least one of A, B, and C” means at least one of A, at least one of B, and/or at least one of C, or any one of A, B, or C or combination of A, B, or C. A, B, and C are elements of a list, and A, B, and C may be anything contained in the Specification.

The present disclosure has described one or more preferred embodiments, and it should be appreciated that many equivalents, alternatives, variations, and modifications, aside from those expressly stated, are possible and within the scope of the invention.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A method for maintaining components of a facility using a customized user interface, the method comprising:
causing a user interface to be presented;
receiving, via the user interface, a request for service to a particular asset at a particular facility, wherein the particular facility is associated with a geographic location, and wherein the particular asset is associated with an asset type;
receiving a ranked list of service providers, wherein a ranking of the ranked list is based on a performance metric associated with each of the plurality of service providers;
presenting, via the user interface, at least a portion of the ranked list;
receiving, via the user interface, a selection of a particular service provider; and
transmitting, to a server, a request to perform the requested service.

2. The method of claim 1, further comprising:
receiving an indication that the particular service provider has accepted the request to perform the requested service;
receiving an indication that the particular service provider has arrived at the particular facility;
determining a response time using a time at which the indication that the service provider has arrived at the particular facility was received;
updating a first of the plurality of attributes based on the response time;
receiving a numerical review of the requested service; and
updating a second of the plurality of attributes based on the numerical review.

3. The method of claim 1, further comprising:
presenting, via the user interface, a plurality of service categories;
receiving, via the user interface, a selection of a category of the plurality of categories;
in response to the selection of the category of the plurality of categories, presenting, via the user interface, a plurality of service capabilities associated with the category of the plurality of categories; and
receiving information indicative of the asset type.

4. The method of claim 3, further comprising:
querying an asset database for assets of the asset type that are associated with the particular facility;
receiving, from the asset database in response to the query, data associated with one or more assets associated with the particular facility;
presenting, via the user interface, the data associated with the one or more assets; and
receiving, via the user interface, a selection of a particular asset included in the one or more assets; and
associating details of the particular asset with the request to perform the requested service.

5. The method of claim 3, further comprising filtering the ranked list of service providers using the asset type.

6. The method of claim 1, further comprising receiving determining an urgency request for the requested service.

7. The method of claim 6, wherein the urgency is determined from at least one of an input via the user interface or using the asset type or an occupancy or user indication associated with the particular asset.

8. The method of claim 6, wherein, if the urgency is determined to be a high urgency, the method further comprises weighting ranked list of service providers using a first plurality of weights preconfigured for urgency.

9. The method of claim 6, wherein, if urgency is determined to be a low urgency, the method further comprises weighting ranked list of service providers using a first plurality of weights preconfigured for no urgency.

10. The method of claim 1, further comprising displaying a prompt via the user interface to indicate whether the request for service is associated with repair of the particular asset or replacement of the particular asset.

11. The method of claim 1, further comprising:
via the user interface, initiating a query of a service provider database for service providers capable of performing the service and with a service area that includes the geographic location associated with the particular facility; and
receiving, via the user interface, data associated with the plurality of service providers.

12. The method of claim 11, further comprising, via the user interface, initiating a further query of the service provider database for service providers capable of performing the requested service and with a service area that is beyond the geographic location associated with the particular facility if an insufficient number of service providers is received in response to the query.

13. The method of claim 1, wherein the plurality of performance attributes comprises:
a speed attribute based on response times;
a price attribute based on an hourly rate; or
a quality attribute based on numerical reviews.

14. The method of claim 1, further comprising selecting a subset of service providers of the plurality of service providers based on the performance metric associated with each of the plurality of service providers, wherein the portion of the ranked list comprises the subset of service providers.

15. The method of claim 14, further comprising:
identifying, from the plurality of service providers, one or more new service providers, wherein new service providers are not associated with data from at least a threshold number of service requests completed within a predetermined period of time;
determining that at least a first new service provider of the one or more new service providers is associated with a rate that is no more than a threshold level above a lowest rate of the plurality of service providers;
adding the first service provider to the subset of service providers.

16. The method of claim 14, wherein generating the ranked list comprises randomly sorting the subset of service providers

17. The method of claim 1, further comprising:
requesting, via the user interface, a plurality of images of the particular asset; and
transmitting, to the server, the plurality of images.

18. The method of claim 1, further comprising:
receiving, via the user interface, a real-time geographic location of a technician associated with a first service provider of the plurality of service providers; and
displaying, via the user interface, an estimated travel time for the technician based on the real-time geographic location and the geographic location associated with the facility;
wherein the performance metric associated with the first service provider is based at least partially on the travel time.

19. (canceled)

20. The method of claim 1, further comprising:
identifying a service provider of the plurality of the service providers that was last used by the particular facility from among the plurality of service providers; and
causing the service provider to be presented via the user interface with a tag indicating that the service provider was the last used service provider.

21. The method of claim 1, further comprising:
identifying a service provider of the plurality of service providers to recommend based on the performance metric; and
causing the service provider to be presented with a tag indicating that the service provider is recommended.

22. The method of claim 21, wherein identifying the service provider of the plurality of service providers to recommend based on the performance metric comprises randomly selecting the service provider from a subset of service providers of the plurality of service providers based on the performance metric associated with each of the plurality of service providers.

23. The method of claim 1, further comprising utilizing a machine learning model to weight the plurality of performance attributes using a plurality of weights based on past selections of service providers.

24. The method of claim 1, further comprising requesting, via the user interface, an indication of whether a technician associated with a service provider has arrived to perform the requested service.

25. The method of claim 1, further comprising receiving an indication that the particular service provider has declined the request to perform the requested service.

26. The method of claim 25, further comprising associating that the particular service provider has declined the request to perform the requested service with the particular service provider in a service provider database.

27. The method of claim 26, wherein associating that the particular service provider has declined the request to perform the requested service with the particular service provider in a service provider database further comprises updating the particular service provider's information associated with capabilities, skills, certifications, coverage areas, or preferences.

28. The method of claim 25, further comprising:
in response to receiving the indication that the particular service provider has declined the request to perform the requested service, prompting via the user interface, a selection of a second service provider from the ranked list of service providers; and
receiving, via the user interface, a selection of the second service provider; and
transmitting, to the server, a request to perform the requested service by the second service provider.

29. The method of claim 25, further comprising:
in response to receiving the indication that the particular service provider has declined the request to perform the requested service, automatically selecting, without user intervention, a second service provider from the ranked list based on the position of each service provider within the ranked list; and
transmitting, to the server, a request to perform the requested service by the second service provider.

30. The method of claim 1, further comprising:
receiving, via the user interface, a second request for service to a second particular asset at a particular facility, wherein the second particular asset is associated with an asset type;
receiving a second ranked list of service providers, wherein a ranking of the second ranked list is based on a performance metric associated with each of the second plurality of service providers;
presenting, via the user interface, at least a portion of the second ranked list;
receiving, via the user interface, a selection of a particular service provider from the at least a portion of the second ranked list; and
transmitting, to the server, a request to perform the requested service based on the selection of the particular service provider from the at least a portion of the second ranked list.

31. (canceled)

32. A method for coordinating maintaining components of a facility across a plurality of facilities, the method comprising:
receiving, at a server, a request from a user device for service to be performed for a particular asset at a particular facility, wherein the particular facility is associated with a geographic location, and wherein the particular asset is associated with an asset type;
compiling a ranked list of service providers, wherein a ranking of the ranked list is based on a performance metric associated with each of the plurality of service providers;
sending, to the user device, at least a portion of the ranked list;
receiving, at the server, a request to have a selected particular service provider perform the requested service at the particular facility; and
communicating the request to perform the requested service at the particular facility to the selected particular service provider.

33-35. (canceled)
